(19) United States
(12) Patent Application Publication
(10) Pub. No.: US 2017/0083096 A1
(43) Pub. Date: Mar. 23, 2017

(54) PRESSURE-BASED HAPTICS

(71) Applicant: Immersion Corporation, San Jose, CA (US)

(72) Inventors: William S. RIHN, San Jose, CA (US); David M. BIRNBAUM, Oakland, CA (US); Anthony Chad SAMPANES, Redwood City, CA (US); Jason D. FLEMING, San Jose, CA (US); Abraham Alexander DAUHAJRE, Coral Springs, FL (US); Ali MODARRES, San Jose, CA (US)

(21) Appl. No.: 15/271,823

(22) Filed: Sep. 21, 2016

Related U.S. Application Data
(60) Provisional application No. 62/222,002, filed on Sep. 22, 2015.
(60) Provisional application No. 62/249,685, filed on Nov. 2, 2015.

(51) Int. Cl. G06F 3/01; G06F 3/041; G06F 3/0488

(52) U.S. Cl. CPC G06F 3/016; G06F 3/04883; G06F 3/0416; G06F 3/0412; G06F 2203/04105

(57) ABSTRACT

A system for processing a user input on a user interface provides an affordance layer that is responsive when the user input includes a touch or tap. The system provides a first interaction layer that is responsive when the user input includes a first pressure of a first threshold. The system provides a second interaction layer that is responsive when the user input includes a second pressure of a second threshold.

### CROSS-REFERENCE

The application claims priority to provisional application 62/222,002, filed Sep. 22, 2015, and also claims priority to provisional application 62,249,685, filed Nov. 2, 2015. Both provisional applications are incorporated by reference fully herein.

### FIELD OF THE INVENTION

One embodiment is directed generally to a user interface for a device, and in particular to haptics and pressure interactions.

### BACKGROUND

Haptics is a tactile and force feedback technology that takes advantage of a user's sense of touch by applying haptic feedback effects (i.e., “haptic effects”), such as forces, vibrations, and motions, to the user. Devices, such as mobile devices, touchscreen devices, and personal computers, can be configured to generate haptic effects. In general, calls to embedded hardware capable of generating haptic effects (such as actuators) can be programmed within an operating system (“OS”) of the device. These calls specify which haptic effect to play. For example, when a user interacts with the device using, for example, a button, touchscreen, lever, joystick, wheel, or some other control, the OS of the device can send a play command through control circuitry to the embedded hardware. The embedded hardware then produces the appropriate haptic effect.

### SUMMARY

One embodiment is a system for processing a user input on a user interface. The system provides an affordance layer that is responsive when the user input includes a touch or tap. The system provides a first interaction layer that is responsive when the user input includes a first pressure of a first threshold. The system provides a second interaction layer that is responsive when the user input includes a second pressure of a second threshold.

### BRIEF DESCRIPTION OF THE DRAWINGS

FIG. 1 illustrates a block diagram of a system in accordance with an embodiment of the invention.

FIG. 2 illustrates a table of design embodiments for pressure-based haptic effects.

FIG. 3 illustrates a graphical representation of an embodiment for providing haptic effects in response to a pressure-based input.

FIG. 4 illustrates a graphical representation of an embodiment for providing haptic effects in response to a pressure-based input.

FIGS. 5A-5D illustrate an embodiment which provides gesture/sensor based effect modulation.

FIG. 6 illustrates an embodiment featuring pressure-based compensation of haptics to maintain user perception consistency.

FIG. 7 illustrates an embodiment featuring a pressure-enabled user generated content.

FIG. 8 illustrates an embodiment which features effect extrapolation with pressure.

FIG. 9 illustrates a table comprising some haptic effects generated by embodiments described herein.

FIG. 10 illustrates current device functionality based on time of interaction in accordance with an embodiment.

FIG. 11 illustrates an embodiment for improving current device functionality.

FIG. 12 illustrates an embodiment which features pressure-based application functionality.

FIG. 13 illustrates an embodiment which features pressure-based rich-sticker interactions.

FIG. 14 illustrates an embodiment which features pressure-based notifications.

FIG. 15 illustrates an embodiment which features pressure-based notification visualization.

FIG. 16 illustrates an embodiment which features pressure-based notification visualization.

FIG. 17 illustrates an embodiment which features pressure-based softkey interaction.

FIG. 18 illustrates an embodiment which features pressure-based security features.

FIG. 19 illustrates an embodiment which features pressure-based notifications.

FIG. 20 illustrates an embodiment which features pressure-based direct to launch application functionality.

FIG. 21 illustrates an embodiment featuring pressure-based interactions for accessories for electronic devices.

FIG. 22 illustrates an embodiment featuring pressure-based media presentations.

FIG. 23 illustrates an embodiment featuring pressure-based device functionality.

FIG. 24 illustrates an embodiment featuring pressure-based map functionality.

FIG. 25 illustrates an embodiment featuring pressure-based peripheral device functionality.

FIG. 26 illustrates an embodiment featuring a pressure-based simulated surface.

FIG. 27 illustrates an embodiment featuring pressure-based peripheral device functionality.

FIG. 28 illustrates an embodiment featuring pressure-based peripheral device functionality.

FIG. 29 illustrates a graph representing a pressure-based simulated surface embodiment.

FIG. 30 illustrates an embodiment featuring pressure-based camera functionality.

FIG. 31 illustrates an embodiment featuring a pressure-based simulated surface.

FIG. 32 illustrates an embodiment featuring pressure-based application functionality.

FIG. 33 illustrates an embodiment of pressure-based functionality.

FIG. 34 illustrates a flowchart regarding an embodiment of a pressure-based application functionality.

FIG. 35 illustrates a flowchart regarding an embodiment of a pressure-based application functionality.

FIG. 36 illustrates a flowchart regarding an embodiment of a pressure-based application functionality.

FIG. 37 illustrates a flowchart regarding an embodiment of a pressure-based application functionality.

FIG. 38 illustrates a flowchart regarding an embodiment of a pressure-based application functionality.

FIG. 39 illustrates a flowchart regarding an embodiment of a pressure-based application functionality.

FIG. 40 illustrates a flowchart regarding an embodiment of a pressure-based application functionality.

FIG. 41 illustrates a flowchart regarding an embodiment of a pressure-based application functionality.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used in another embodiment to yield a still further embodiment. Thus, it is intended that this disclosure include modifications and variations that come within the scope of the appended claims and their equivalents.

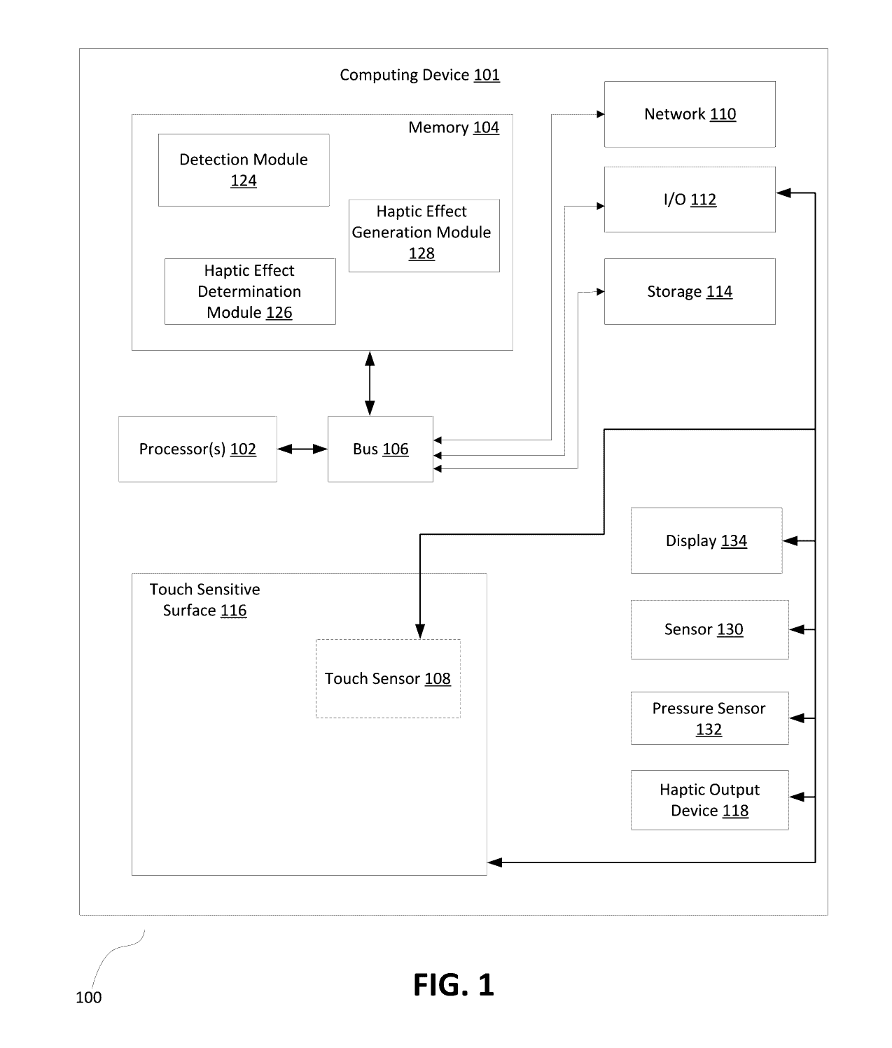

FIG. 1 is a block diagram showing a system 100 for pressure-based haptic effects according to one embodiment. As shown in FIG. 1, system 100 includes a computing device 101. Computing device 101 may include, for example, a mobile phone, tablet, e-reader, laptop computer, desktop computer, car computer system, medical device, game console, game controller, or portable gaming device. Further, in some embodiments, computing device 101 may include a multifunction controller, for example, a controller for use in a kiosk, automobile, alarm system, thermostat, or other type of computing device. While system 100 is shown as a single device in FIG. 1, in other embodiments, system 100 may include multiple devices, such as a game console and one or more game controllers.

Computing device 101 includes a processor 102 in communication with other hardware via bus 106. A memory 104, which can include any suitable tangible (and non-transitory) computer-readable medium such as RAM, ROM, EEPROM, or the like, embodies program components that configure operation of computing device 101. In the embodiment shown, computing device 101 further includes one or more network interface devices 110, input/output (I/O) components 112, and storage 114.

Network interface device 110 can represent one or more of components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network).

I/O components 112 may be used to facilitate wired or wireless connection to devices such as one or more displays 134, game controllers, keyboards, mice, joysticks, cameras, buttons, speakers, microphones, and/or other hardware used to input data or output data. Storage 114 represents nonvolatile storage such as magnetic, optical, or other storage media included in computing device 101 or coupled to processor 102.

System 100 further includes a touch sensitive surface 116 which, in this example, is integrated into computing device 101. Touch sensitive surface 116 represents any surface that is configured to sense tactile input of a user. One or more touch sensors 108 are configured to detect a touch in a touch area when an object contacts a touch sensitive surface 116 and provide appropriate data for use by processor 102. Any suitable number, type, or arrangement of sensors can be used. For example, resistive and/or capacitive sensors may be embedded in touch sensitive surface 116 and used to determine the location of a touch and other information, such as pressure, speed, and/or direction. As another example, optical sensors with a view of touch sensitive surface 116 may be used to determine the touch position.

In other embodiments, touch sensor 108 may include an LED heartbeat detector. For example, in one embodiment, touch sensitive surface 116 may include an LED heartbeat detector mounted on the side of a display 134. In some embodiments, processor 102 is in communication with a single touch sensor 108, in other embodiments, processor 102 is in communication with a plurality of touch sensors 108, for example, a first touch screen and a second touch screen. Touch sensor 108 is configured to detect user interaction, and based on the user interaction, transmit signals to processor 102. In some embodiments, touch sensor 108 may be configured to detect multiple aspects of the user interaction. For example, touch sensor 108 may detect the speed and pressure of a user interaction, and incorporate this information into the interface signal.

Touch sensitive surface 116 may or may not include (or otherwise correspond to) display 134, depending on the particular configuration of system 100. Some embodiments include a touch enabled display that combines a touch sensitive surface 116 and display 134 of the device. Touch sensitive surface 116 may correspond to display 134 exterior or one or more layers of material above components shown on display 134. In some embodiments, computing device 101 includes a touch sensitive surface 116 that may be mapped to a graphical user interface provided in a display 134 included in system 100 and interfaced to computing device 101.

System 100 further includes a pressure sensor 132. Pressure sensor 132 is configured to detect an amount of pressure exerted by a user against a surface associated with computing device 101 (e.g., touch sensitive surface 116). Pressure sensor 132 is further configured to transmit sensor signals to processor 102. Pressure sensor 132 may include, for example, a capacitive sensor, a strain gauge, a force sensitive resistor, or a FSR. In some embodiments, pressure sensor 132 may be configured to determine the surface area of a contact between a user and a surface associated with computing device 101. In some embodiments, touch sensitive surface 116 or touch sensor 108 may include pressure sensor 132.

System 100 includes one or more additional sensors 130. In some embodiments, sensor 130 may include, for example, a camera, a gyroscope, an accelerometer, a global positioning system (GPS) unit, a temperature sensor, a strain gauge, a force sensor, a range sensor, or a depth sensor. In some embodiments, the gyroscope, accelerometer, and GPS unit may detect an orientation, acceleration, and location of computing device 101, respectively. In some embodiments, the camera, range sensor, and/or depth sensor may detect a distance between computing device 101 and an external object (e.g., a user's hand, head, arm, foot, or leg; another person; an automobile; a tree; a building; or a piece of furniture). Although the embodiment shown in FIG. 1 depicts sensor 130 internal to computing device 101, in some embodiments, sensor 130 may be external to computing device 101. For example, in some embodiments, the one or more sensors 130 may be associated with a wearable device (e.g., a ring, bracelet, sleeve, collar, hat, shirt, glove, article of clothing, or glasses) and/or coupled to a user's body. In some embodiments, processor 102 may be in communication with a single sensor 130 and, in other embodiments, processor 102 may be in communication with a plurality of sensors 130, for example, a gyroscope and an accelerometer. Sensor 130 is configured to transmit a sensor signal to processor 102.

System 100 further includes a haptic output device 118 in communication with processor 102. Haptic output device 118 is configured to output a haptic effect in response to a haptic signal. In some embodiments, the haptic effect may include, for example, one or more of a vibration, a change in a perceived coefficient of friction, a simulated texture, a change in temperature, a stroking sensation, an electro-tactile effect, or a surface deformation.

In the embodiment shown in FIG. 1, haptic output device 118 is in communication with processor 102 and internal to computing device 101. In other embodiments, haptic output device 118 may be remote from computing device 101, but communicatively coupled to processor 102. For example, haptic output device 118 may be external to and in communication with computing device 101 via wired interfaces such as Ethernet, USB, IEEE 1394, and/or wireless interfaces such as IEEE 802.11, Bluetooth, or radio interfaces. In some embodiments, haptic output device 118 may be coupled to a wearable device that may be remote from computing device 101. In some embodiments, the wearable device may include a shoe, a sleeve, a jacket, glasses, a glove, a ring, a watch, a wristband, a bracelet, an article of clothing, a hat, a headband, and/or jewelry. In such an embodiment, the wearable device may be associated with a part of a user's body, for example, a user's finger, arm, hand, foot, leg, head, or other body part.

In some embodiments, haptic output device 118 may be configured to output a haptic effect comprising a vibration. Haptic output device 118 may include, for example, one or more of a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA).

In some embodiments, haptic output device 118 may be configured to output a haptic effect comprising a change in a perceived coefficient of friction on a surface associated with computing device 101 (e.g., touch sensitive surface 116). In one embodiment, haptic output device 118 includes an ultrasonic actuator. The ultrasonic actuator may vibrate at an ultrasonic frequency, for example >20 kHz, increasing or reducing the perceived coefficient on a surface associated with computing device 101 (e.g., touch sensitive surface 116). In some embodiments, the ultrasonic actuator may include a piezoelectric material.

In other embodiments, haptic output device 118 may use electrostatic attraction, for example by use of an electrostatic actuator, to output a haptic effect. In such an embodiment, the haptic effect may include a simulated texture, a simulated vibration, a stroking sensation, or a perceived change in a coefficient of friction on a surface associated with computing device 101 (e.g., touch sensitive surface 116). In some embodiments, the electrostatic actuator may include a conducting layer and an insulating layer. The conducting layer may be any semiconductor or other conductive material, such as copper, aluminum, gold, or silver. The insulating layer may be glass, plastic, polymer, or any other insulating material. Furthermore, processor 102 may operate the electrostatic actuator by applying an electric signal, for example an AC signal, to the conducting layer. In some embodiments, a high-voltage amplifier may generate the AC signal. The electric signal may generate a capacitive coupling between the conducting layer and an object (e.g., a user's finger, head, foot, arm, shoulder, leg, or other body part, or a stylus) near or touching haptic output device 118. In some embodiments, varying the levels of attraction between the object and the conducting layer can vary the haptic effect perceived by a user interacting with computing device 101.

In some embodiments, haptic output device 118 may include a deformation device. The deformation device may be configured to output a haptic effect by deforming a surface associated with haptic output device 118 (e.g., a housing of computing device 101 or touch sensitive surface 116). In some embodiments, haptic output device 118 may include a smart gel that responds to a stimulus or stimuli by changing in stiffness, volume, transparency, and/or color. In some embodiments, stiffness may include the resistance of a surface associated with haptic output device 118 against deformation. In one embodiment, one or more wires are embedded in or coupled to the smart gel. As current runs through the wires, heat is emitted, causing the smart gel to expand or contract, deforming the surface associated with haptic output device 118.

In other embodiments, haptic output device 118 may include an actuator coupled to an arm that rotates a deformation component. The actuator may include a piezoelectric actuator, rotating/linear actuator, solenoid, an electroactive polymer actuator, macro fiber composite (MFC) actuator, shape memory alloy (SMA) actuator, and/or other actuator. As the actuator rotates the deformation component, the deformation component may move a surface associated with haptic output device 118, causing it to deform. In some embodiments, haptic output device 118 may include a portion of the housing of computing device 101 or a component of computing device 101. In other embodiments, haptic output device 118 may be housed inside a flexible housing overlaying computing device 101 or a component of computing device 101.

In some embodiments, haptic output device 118 may be configured to output a thermal or electro-tactile haptic effect. For example, haptic output device 118 may be configured to output a haptic effect comprising a change in a temperature of a surface associated with haptic output device 118. In some embodiments, haptic output device 118 may include a conductor (e.g., a wire or electrode) for outputting a thermal or electro-tactile effect. For example, in some embodiments, haptic output device 118 may include a conductor embedded in a surface associated with haptic output device 118. Computing device 101 may output a haptic effect by transmitting current to the conductor. The conductor may receive the current and, for example generate heat, thereby outputting the haptic effect.

Although a single haptic output device 118 is shown here, some embodiments may use multiple haptic output devices of the same or different type to provide haptic feedback. Some haptic effects may utilize an actuator coupled to a housing of the device, and some haptic effects may use multiple actuators in sequence and/or in concert. For example, in some embodiments, multiple vibrating actuators and electrostatic actuators can be used alone or in concert to provide different haptic effects. In some embodiments, haptic output device 118 may include a solenoid or other force or displacement actuator, which may be coupled to touch sensitive surface 116. Further, haptic output device 118 may be either rigid or flexible.

Turning to memory 104, program components 124, 126, and 128 are depicted to show how a device can be configured in some embodiments to provide pressure-based haptic effects. In this example, a detection module 124 configures processor 102 to monitor touch sensitive surface 116 via touch sensor 108 to determine a position of a touch. For example, detection module 124 may sample touch sensor 108 in order to track the presence or absence of a touch and, if a touch is present, to track one or more of the location, path, velocity, acceleration, pressure and/or other characteristics of the touch.

Haptic effect determination module 126 represents a program component that analyzes data to determine a haptic effect to generate. Haptic effect determination module 126 may include code that determines, for example, based on an interaction with touch sensitive surface 116, a haptic effect to output and code that selects one or more haptic effects to provide in order to output the effect. For example, in some embodiments, some or all of the area of touch sensitive surface 116 may be mapped to a graphical user interface. Haptic effect determination module 126 may select different haptic effects based on the location of a touch in order to simulate the presence of a feature (e.g., a virtual avatar, automobile, animal, cartoon character, button, lever, slider, list, menu, logo, or person) on the surface of touch sensitive surface 116. In some embodiments, these features may correspond to a visible representation of the feature on the interface. However, haptic effects may be output even if a corresponding element is not displayed in the interface (e.g., a haptic effect may be provided if a boundary in the interface is crossed, even if the boundary is not displayed).

In some embodiments, haptic effect determination module 126 may select a haptic effect based at least in part a characteristic (e.g., a virtual size, width, length, color, texture, material, trajectory, type, movement, pattern, or location) associated with a virtual object. For example, in one embodiment, haptic effect determination module 126 may determine a haptic effect comprising a vibration if a color associated with the virtual object is blue. In such an embodiment, haptic effect determination module 126 may determine a haptic effect comprising a change in temperature if a color associated with the virtual object is red. As another example, haptic effect determination module 126 may determine a haptic effect configured to simulate the texture of sand if the virtual object includes an associated virtual texture that is sandy or coarse.

In some embodiments, haptic effect determination module 126 may select a haptic effect based at least in part on a signal from pressure sensor 132. That is, haptic effect determination module 126 may determine a haptic effect based on the amount of pressure a user exerts against a surface (e.g., touch sensitive surface 116) associated with computing device 101. For example, in some embodiments, haptic effect determination module 126 may output a first haptic effect or no haptic effect if the user exerts little or no pressure against the surface. In some embodiments, haptic effect determination module 126 may output a second haptic effect or no haptic effect if the user exerts low pressure against the surface. Further, in some embodiments, haptic effect determination module 126 may output a third haptic effect or no haptic effect if the user exerts a firm pressure against the surface. In some embodiments, haptic effect determination module 126 may associate different haptic effects with no pressure, soft pressure, and/or firm pressure. In other embodiments, haptic effect determination module 126 may associate the same haptic effect with no pressure, soft pressure, and/or firm pressure.

In some embodiments, haptic effect determination module 126 may include a finite state machine. A finite state machine may include a mathematical model of computation. Upon applying an input to the mathematical model, the finite state machine may transition from a current state to a new state. In such an embodiment, the finite state machine may select haptic effects based on the transition between states. In some embodiments, these state transitions may be driven based in part on a sensor signal from pressure sensor 132.

In some embodiments, haptic effect determination module 126 may include code that determines a haptic effect based at least in part on signals from sensor 130 (e.g., a temperature, an amount of ambient light, an accelerometer measurement, or a gyroscope measurement). For example, in some embodiments, haptic effect determination module 126 may determine a haptic effect based on the amount of ambient light. In such embodiments, as the ambient light decreases, haptic effect determination module 126 may determine a haptic effect configured to deform a surface of computing device 101 or vary the perceived coefficient of friction on a surface associated with haptic output device 118. In some embodiments, haptic effect determination module 126 may determine haptic effects based on the temperature. For example, as the temperature decreases, haptic effect determination module 126 may determine a haptic effect in which the user perceives a decreasing coefficient of friction on a surface associated with haptic output device 118.

Haptic effect generation module 128 represents programming that causes processor 102 to transmit a haptic signal to haptic output device 118 to generate the selected haptic effect. For example, haptic effect generation module 128 may access stored waveforms or commands to send to haptic output device 118. As another example, haptic effect generation module 128 may include algorithms to determine the haptic signal. Haptic effect generation module 128 may include algorithms to determine target coordinates for the haptic effect. These target coordinates may include, for example, a location on touch sensitive surface 116.

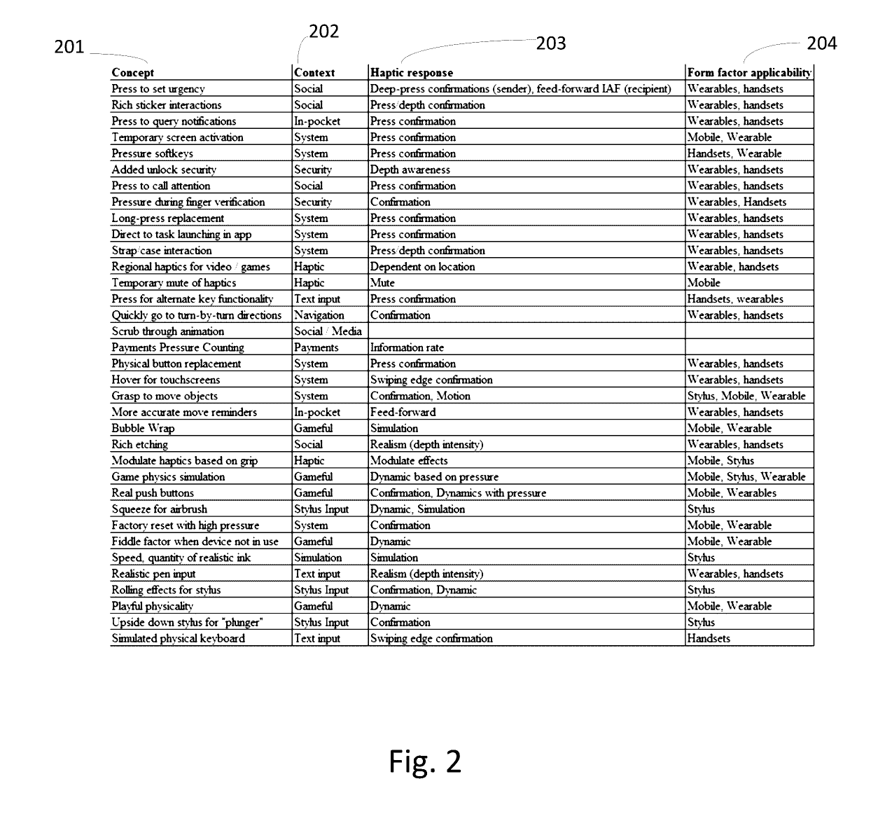

FIG. 2 illustrates a set of design embodiments for pressure-based haptic effect systems. Within the non-exclusive set of design embodiments, the embodiments, identified as concepts 201, may be classified or approximated by a context 202 in which a particular embodiment may be activated. For example, various embodiments may be considered to be one of social, in-pocket, system, security, haptic, text input, navigation, social/media, payments, gameful, stylus output, and simulation.

Within a classification of social context embodiments, a number of concepts may be realized. A non-exclusive list of social context embodiments includes a press to set urgency, rich sticker interactions, a press to call attention, rich etching, and the like. A non-exclusive list of in-pocket context embodiments includes a press to query notifications, more accurate move reminders, and the like. A non-exclusive list of system context embodiments includes a temporary screen activation, pressure softkeys, long-press replacement, direct to task launching in applications, strap/case interactions, physical button replacement, hover for touchscreens, grasp to move objects, factory reset with high pressure, and the like. A non-exclusive list of security context embodiments includes added unlock security, pressure during finger verification, and the like. A non-exclusive list of haptic context embodiments includes regional haptics for video/games, temporary mute of haptics, modulate haptics based on grip, and the like. A non-exclusive list of haptic context embodiments includes a press for alternate key functionality, a realistic pen input, a simulated physical keyboard, and the like. A non-exclusive list of navigation context embodiments include quickly going to turn-by-turn directions and the like. A non-exclusive list of social/media context embodiments includes scrubbing through animation and the like. A non-exclusive list of payments context embodiments includes payments pressure counting and the like. A non-exclusive list of gameful context embodiments includes bubble wrap, game physics simulation, real push buttons, fiddle factor when device not in use, playful physicality, and the like. A non-exclusive list of stylus-input context embodiments includes a squeeze for airbrush, an upside down stylus for a “plunger,” and the like. A non-exclusive list of simulation context embodiments includes speed and quantity of realistic ink and the like.

Amongst the design embodiments of FIG. 2, a number of different haptic responses 203 may be implemented for each concept. A non-exclusive list of haptic responses 203 includes deep-press confirmations, feed-forward IAFs, press/depth confirmation, depth awareness, dependent on location, mute, information rate, confirmation, swiping edge confirmation, motion, simulation, realism, depth intensity, modulate effects, dynamic based on pressure, dynamics with pressure, and the like.

Amongst the design embodiments of FIG. 2, a number of different form factor applicabilities 204 may be used for each concept. A non-exclusive list of form factor applicability includes wearables, handsets, mobile devices, stylus, and the like.

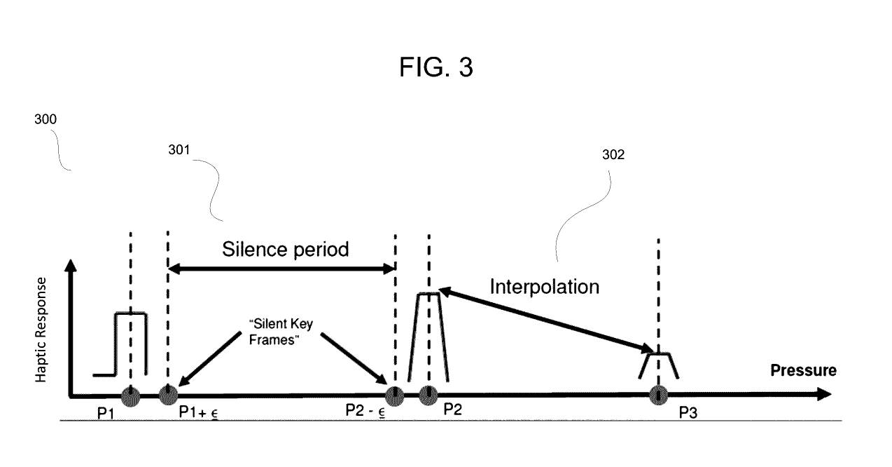

FIG. 3 illustrates a graphical representation of an embodiment for providing haptic effects in response to a pressure-based input. While active, a device such as system 100 monitors for a pressure values or “key frames” P1, P2, P3, . . . PN. If pressure value P1 is detected by some pressure gesture applied to a surface, the system may or may not take some action, and continue monitoring for pressure values P2, P3, . . . PN. Silent key frames, called P1+C and P2−C in the figure, ensure that the haptic response stops when these pressure values are reached or crossed. When pressure values fall between P1 and P2, no haptic effect will be produced and no interpolation is required, because the values between two silent key frames constitute a silent period 301. Between key frames P2 and P3, the system provides interpolation 302 between the haptic output values associated with key frames P2 and P3, to provide transitional haptic effects between the haptic response accompanying P2 and the haptic response accompanying P3. Interpolation and interpolated effects are features employed to modulate or blend effects associated with multiple specified haptic feedback effects. The functionality of FIG. 3 provides the ability to distinguish between haptic effects to be played when pressure is increasing and haptic effects to be played when pressure is decreasing. The functionality of FIG. 3 further prevents haptic effects from being skipped when pressure increases too fast. For example, when pressure goes from 0 to max, all effects associated with the interim pressure levels will be played. Further, a silence gap will be implemented between the effects in case they need to be played consecutively.

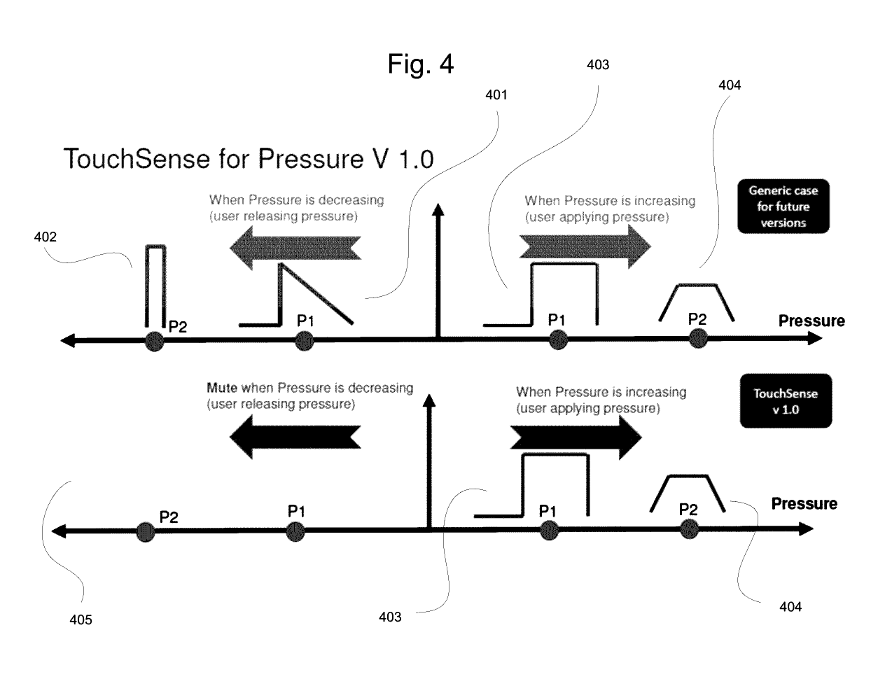

FIG. 4 illustrates a graphical representation of an embodiment for providing haptic effects in response to a pressure-based input. In one embodiment, the system identifies whether P2 is a larger or smaller magnitude than P1 and may provide different haptic responses based on whether the pressure applied is increasing or decreasing. In some embodiments, increasing and decreasing pressure situations result in two different sets of haptic responses, with haptic responses 401, 402 corresponding to decreasing pressure application and haptic responses 403, 404 corresponding to increasing pressure application. In some embodiments, increasing pressure situations will generate haptic responses, while decreasing pressure situations will result in no haptic effect 405. As in FIG. 3, different haptic effects 401-404 may be generated in response to multiple levels of pressure being applied. Silent key frames are utilized in embodiments where effect interpolation is not the intended outcome. As multiple pressure levels are applied, i.e., P1, P2, P3, . . . PN, an embodiment ensures that each effect associated with each pressure level is generated. In an embodiment, a silence gap may be generated between subsequent effects to ensure the user is able to distinguish and understand the haptic feedback.

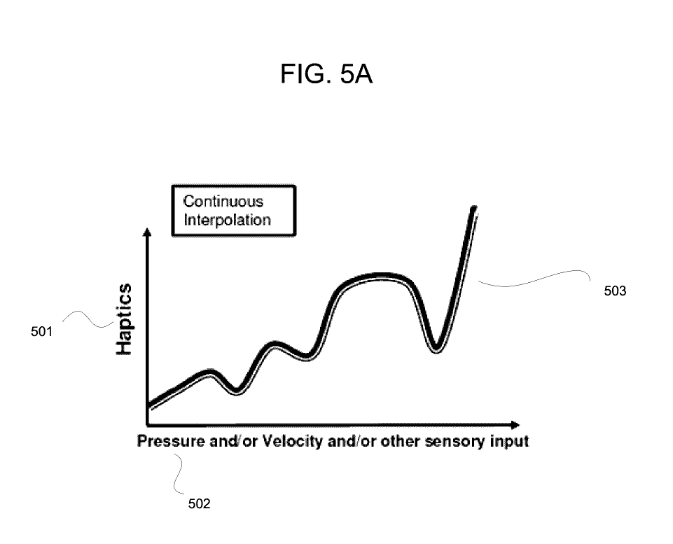

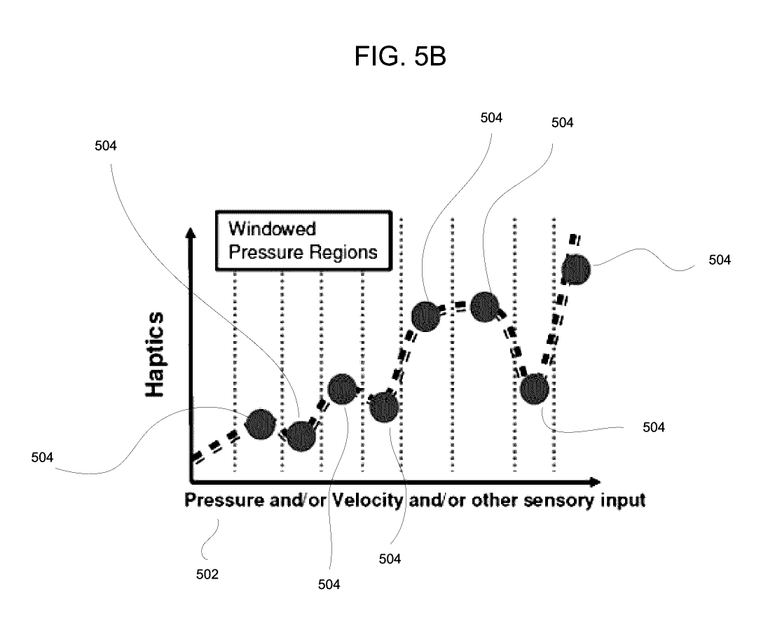

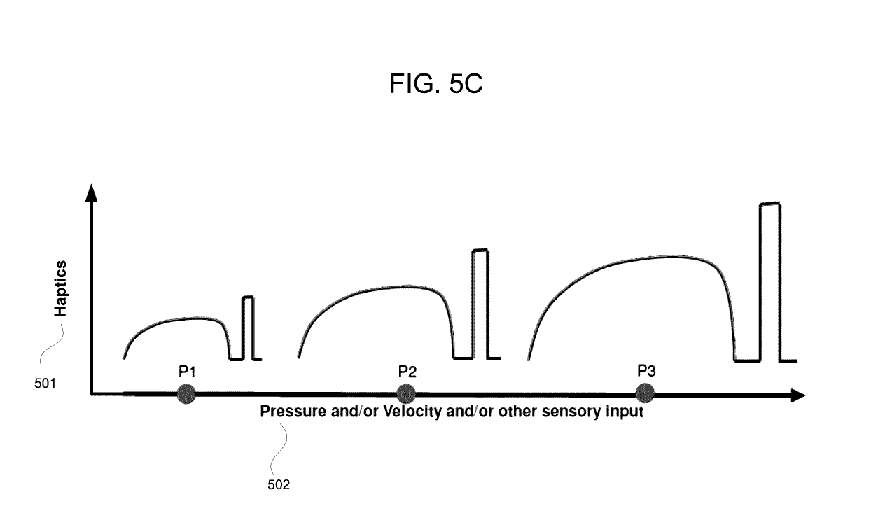

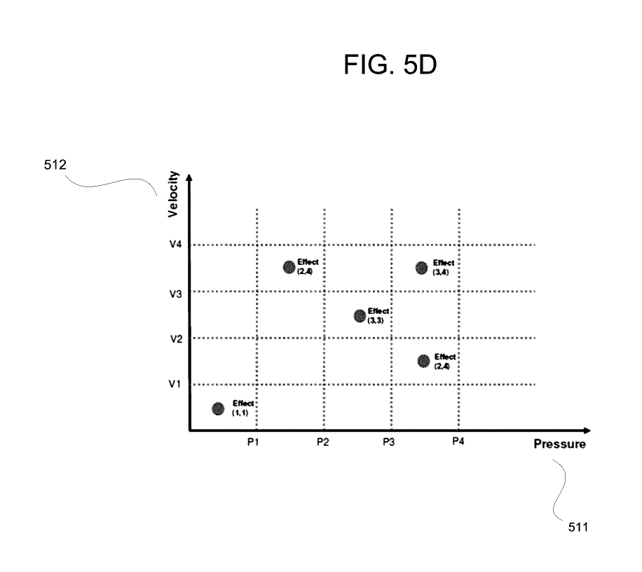

FIGS. 5A, 5B, 5C, and 5D illustrate an embodiment which provides gesture/sensor based effect modulation. Haptic effects 501 may be provided and may be modulated against pressure 502 or pressure with a two dimensional gesture velocity (velocity being one of a non-exclusive sensed parameter in addition to pressure which may be used to modulate a produced haptic effect). In FIG. 5A, an embodiment provides continuous interpolation 503 across multiple pressure levels being applied or input. In FIG. 5B, an embodiment provides discrete haptic effects 504 within windowed pressure regions. In the embodiments illustrated in both FIGS. 5A and 5B, effects on either side of a threshold boundary point may be mixed in the event of pressure being applied at that threshold boundary point between levels. As illustrated in FIG. 5C, an embodiment provides freeform, or timeline, interpolation. As illustrated in FIG. 5D, haptic effects may be generated in response to more than one parameter; in this embodiment, a haptic effect is generated in response to a measured pressure 511 and velocity 512 as, e.g., a gesture is applied to a device. The embodiment may provide for a mapping of pressure/velocity/other sensory inputs to effect parameters. Multiple sensory inputs may also be combined into one single parameter against which haptics can be modulated.

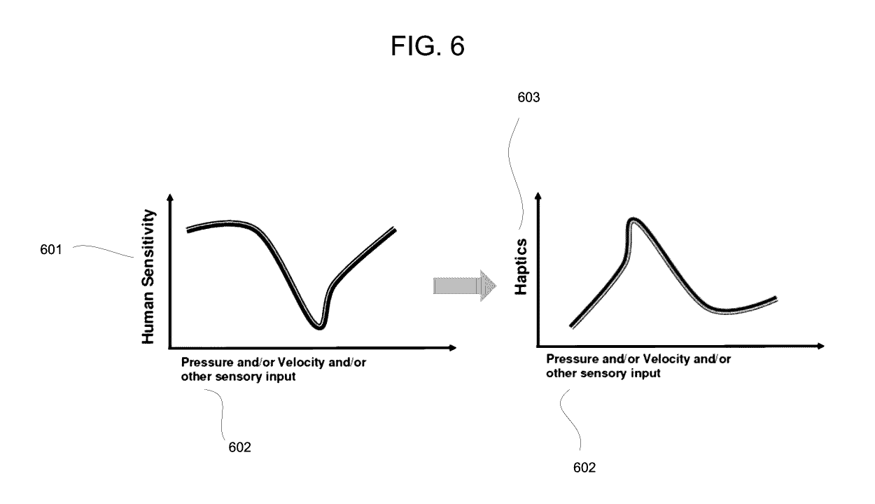

FIG. 6 illustrates an embodiment featuring pressure-based compensation of haptics to maintain user perception consistency. The embodiment recognizes that sensitivity for a user may decrease for higher pressure within a certain threshold. Additionally, the embodiment recognizes that other sensor values (motion/acceleration/etc.) may have an impact on human perception sensitivity. As illustrated in FIG. 6, haptics may be modulated constantly for different levels of pressure (and/or other inputs) to compensate for changes in perception ability of the user. The modulation results in maintaining perceived tactile sensation. As illustrated in FIG. 6, as human sensitivity 601 decreases with increased input 602, haptic output 603 may increase to compensate.

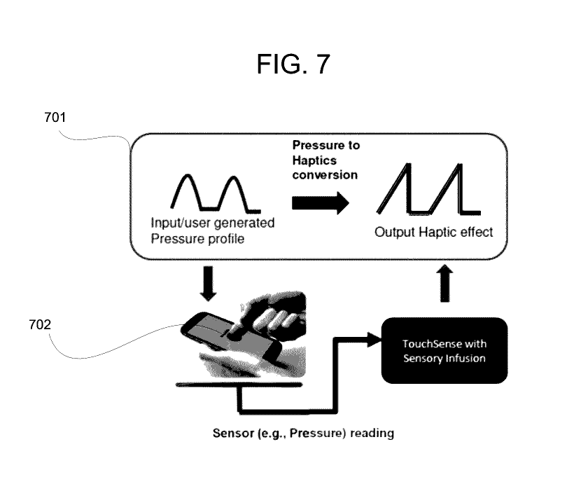

FIG. 7 illustrates an embodiment featuring a pressure-enabled user generated content (“UGC”). In the embodiment illustrated in FIG. 7, an automatic pressure-to-haptics conversion 701 occurs as a user inputs content 702, such as a profile. For example, a pressure input plus a rhythm/pattern input results in a high level tactile interaction. The embodiment of FIG. 7 may be useful at least with UGC and augmented communication/stickers.

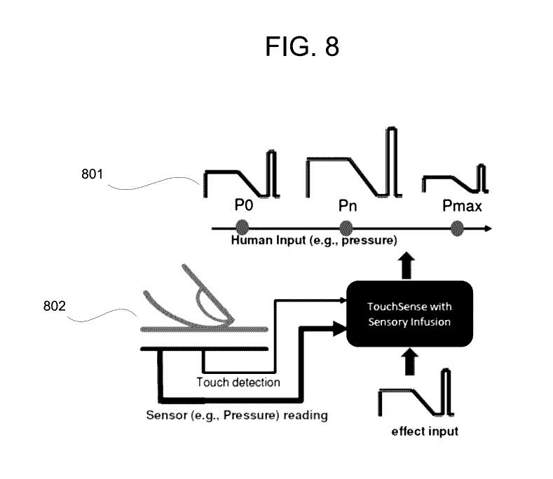

FIG. 8 illustrates an embodiment which features effect extrapolation with pressure. In the embodiment of FIG. 8, automatic extrapolation of a single haptics effect 801 over a range of pressure values P₀, P₁, Pₘₐₓ may be provided. Here, an interaction 802 between a user and a device surface is detected and processed. Such an embodiment is particularly applicable to, e.g., a simulated mechanical button or gas pedal, or any deformable/rigid object.

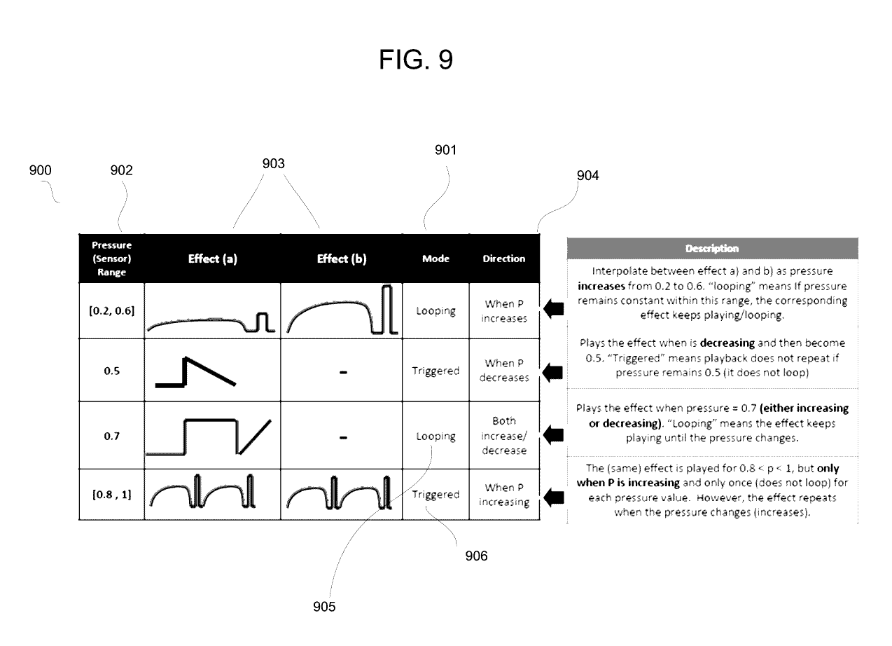

FIG. 9 illustrates a table 900 including some effects envisioned in the embodiments described herein. As discussed previously, a mode 901, such as “looping” 905, may provide for multiple effects within predefined pressure ranges 902, the ranges being set or user-defined, and may generate effects 903 based on a direction 904 of changing pressure, i.e., either increasing or decreasing. Another option includes a triggered mode 906, whereby an effect is triggered but does not loop. In a triggered mode, a particular pressure application may serve as the trigger. Additionally, a mode may be selected to determine whether transitions between effects should be “smooth” or “abrupt.” Such a determination may be factory set or user defined and pertains to effect transitions/mixing as a user goes through various pressure levels, specifically quickly or back and forth. The determination of mode may be made based on actuator performance characteristics.

An example includes an embodiment which provides a haptic effect based on a use of a first force signal and a second force signal different from the first force signal. The use of a first force signal and second, different, force signal, allows the system to set one of a number of triggers for a haptic effect. For example, an urgency level associated with a graphical icon, scaling a visual size of a sticker or graphical icon, determining a number of notifications associated with the housing of a haptically-enabled pocket device, determining a display screen temporary activation time associated with the housing of a haptically-enabled device, setting a confirmation level associated with a softkey button, setting an unlock security confirmation level associated with an unlock security sequence, generating a direct-to-launch interaction parameter associated with a graphical icon representing an application-specific area, and the like.

Another example includes an embodiment that determines if a user input signal is less than a force detection threshold, the user input signal being associated with a pressure-enabled area, and then generating a pressure-enabled parameter using the input signal and the threshold.

Haptic feedback is uniquely suited to present real-time sensory feedback during pressure interactions. The human sensory system has trouble judging how hard the body is pushing without the presence of tactile feedback. This makes pressure interactions difficult to control with no haptics. Pressure sensing solutions can go beyond simply sensing when a threshold is crossed; they can provide significant dynamic range and a high enough sampling rate to capture nuanced changes in the amount of pressure a finger exerts on the screen. With this new interaction design opportunity comes unique and significant problems for ergonomics and usability, which haptics can solve.

According to embodiments herein, improved pressure sensing solutions are able to go beyond simply sensing when a pre-defined threshold is crossed. According to embodiments described herein, pressure sensing may provide significant dynamic range and a high enough sampling rate to capture nuanced changes in an amount of pressure applied by a user with, e.g., a finger.

Pressure input may be better for temporary states or secondary actions than an extended duration hard press due to a higher likelihood of fatigue in an extended duration hard press situation.

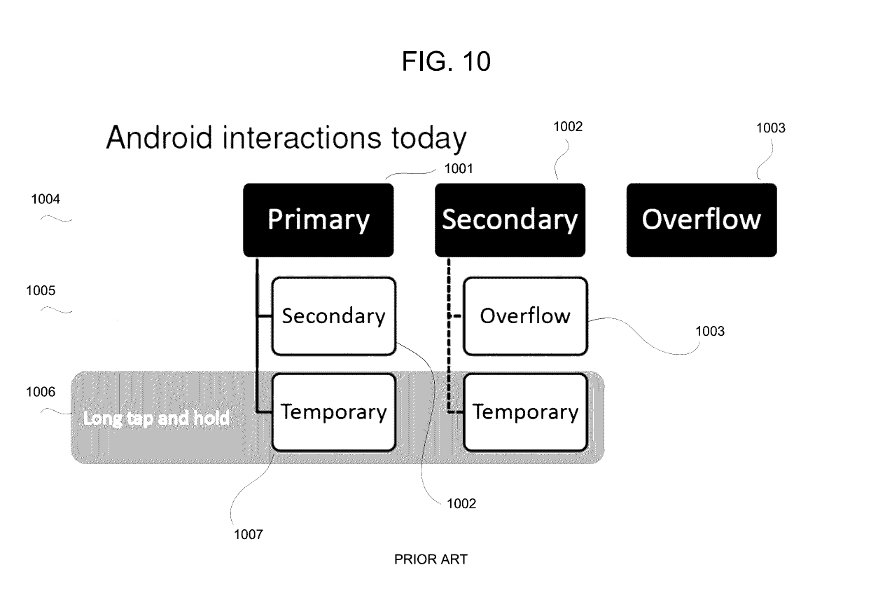

As illustrated in FIG. 10, known operating systems may provide primary 1001, secondary 1002, and overflow functions 1003 in response to an interaction with a device, beginning with a tap 1004. In the event of a long tap gesture 1005 on an interactive element providing a secondary function 1001, a secondary response 1002 may be triggered. In the event of a long tap gesture 1005 on an interactive element providing a secondary function, an overflow response 1003 may be provided. In the event of a user-provided long tap and hold 1006, the interactive element may provide a temporary response 1007. Haptic feedback effects that depend on pressure gesture input can help the user understand which function is being accessed: a primary function, a secondary function, an overflow function, or a temporary function.

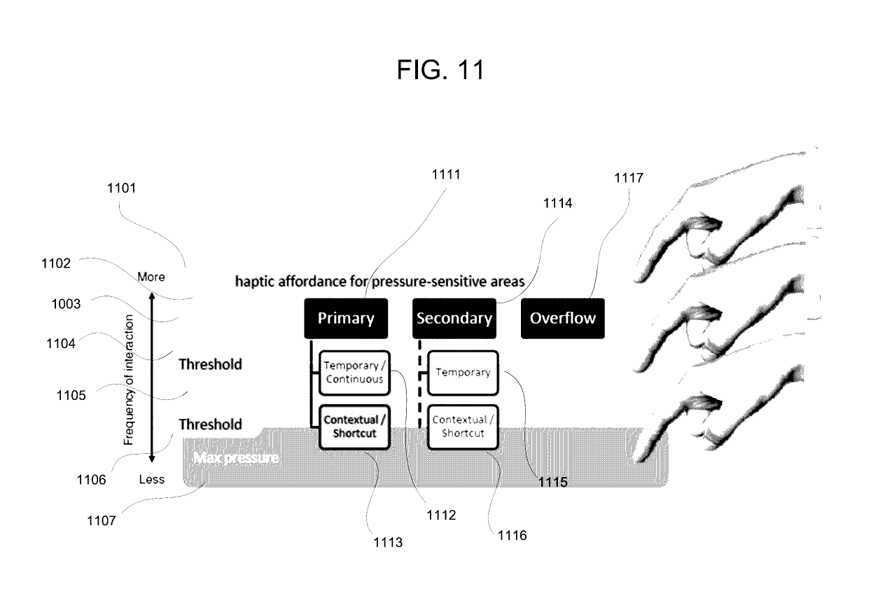

FIG. 11 illustrates an embodiment which includes augmenting interactions with a device based on pressure sensitivity. Touch haptic affordance may be provided for pressure-sensitive areas by providing haptic feedback that takes the form of a haptic affordance layer 1101. Affordance layer 1101 provides a user with an ability to touch a surface superficial to pressure-sensitive areas with a minimal amount of force or contact without activating the pressure-based responses. As is generally known, an “affordance” may include the actionable properties between the world and an actor such a person or animal, and may also include a perceived affordance as to whether an actor such as a computer system user perceives that some action is possible (or in the case of perceived non-affordances, not possible). For example, typical computer system affordances may include a keyboard, display screen, pointing device (e.g., mouse) and selection buttons (e.g., mouse buttons), touch screen or touch pad, and force detection sensors, which afford pointing, touching, looking, clicking, and applying pressure on every pixel of a display screen. If the display does not have a touch-sensitive screen, the screen still affords touching, but may have no result on the computer system. Touch sensitive screens make affordance visible by displaying a cursor. Embodiments such as shown in FIG. 11 enable affordance of the pressure sensitive interaction to be perceptible through the use of haptics.

Primary 1111, secondary 1114 and overflow 1117 functionality in FIG. 11 can be entered in a similar manner as in FIG. 10 in one embodiment. Beneath haptic affordance layer 1101 (passed by applying pressure greater than an initial threshold 1102), each of at least N (illustrated as two) levels of pressure input may be separated by separate and discrete thresholds. Each threshold may be based on an amount of pressure, a duration of pressure, a frequency of pressure, or the like. For example, when accessing a primary function, upon crossing a first threshold 1104, a primary response associated with a light tap may be altered to be of a temporary/continuous nature associated with one of N pressure levels 1105, and upon crossing a second threshold 1106, a different or modified response 1113 may be provided of a contextual/shortcut nature until input reaches a max pressure 1107. Similarly, in a secondary interaction 1114, upon crossing a first threshold 1104, a response 1115 may be provided of a temporary nature, and upon crossing a second threshold 1106, a different or modified response 1116 may be provided of a contextual/shortcut nature. When the pressure input value reaches its maximum, a haptic effect can be used to communicate to the user that pressing with stronger force will have no effect on the interaction.

An embodiment includes the use of temporary menus which may be prioritized or reprioritized due to actions by the user. A device may provide a persistent contextual menu from which temporary menus may be reprioritized due to additional actions the persistent contextual menu may offer.

In an embodiment, control of a device may be accomplished by a pressure interaction model. In a pressure interaction model, haptics may be generated in response to multiple different levels of pressure separated by thresholds with each different level corresponding to a different effect. At a top level, a touch may initiate a response or a touch being a tap may begin a response by the device. A plurality of continuous and/or threshold based effects may be elicited from the device as subsequent thresholds are crossed. The thresholds may be crossed by application of continuous or increasing pressure up through a maximum pressure.

In a simplified pressure interaction, a device provides a plurality of layers with which a user may interact. The device may include at least an affordance or top layer, at least a first pressure layer (with up to N total layers), and a max pressure layer which may be accessed by applying enough pressure to go “through” the affordance layer and all of the first through nth pressure layers. Pressure enables complexity in gesture input, sometimes without visual feedback. Haptics and haptic responses are necessary to ensure the user understands the complexity. Haptics allow the user to interact with a device without needing to rely exclusively on a traditional visual affordance.

Haptics provide at least three categories of opportunity for improving response characteristics of a device, including design flexibility, ergonomics, and meaning. Design flexibility includes enabling new affordances with haptics, reducing interface clutter with new modal information, enabling new industrial design possibilities, and enabling interaction design in a z-plane (i.e., perpendicular to a display surface of the device). Ergonomics includes haptic responses based on locations and trajectory of force, representing depth by pressure via haptic thresholds, reducing user error capacitive touch sensors, and changing pressure and haptic parameters based on a device-body relationship. Meaning includes receiving informational data from a device via pressure depths, playful and unique interactions with continuous pressure input, and causing a multimodal response where haptics are synced to another modality.

In providing haptic responses, a variety of concepts may be classified according to a context in which a user might encounter them. The concepts may be classified according to a context, haptic response type, form factor applicability, verticality, primitives, and demo types. Amongst the primitives, at least a z-axis interaction, a secondary action, a simulation action, an ergonomic action, are possible interaction types.

With regards to a z-axis interaction, which may be used in a continuous manner, a user may use the axis of pressure threshold to denote settings similar to those used in a discrete slider.

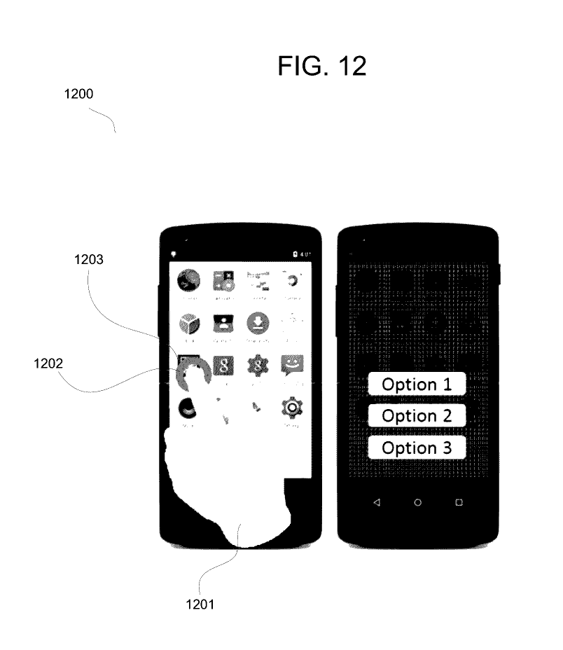

Regarding contextual secondary action(s), FIG. 12 illustrates an example which has a primary benefit of providing faster access to secondary actions. Contextual secondary action(s) add a new contextual function to an existing user interface (“UI”) element. Contextual secondary actions reduce a number of taps and navigation steps to access common functions. For example, in a system 1200, a user 1201 may interact with a device and apply pressure at a location 1202 corresponding to an icon 1203. Depending on an amount of pressure applied, the interaction may provide the user with option 1, option 2, or option 3, each option displaying in conjunction with a haptic response being generated.

Regarding simulation, a user may use pressure to simulate realism, such as the multiple tactile sensations of a mechanical keyboard or the feeling of popping bubble wrap.

Some concepts may be considered to be prioritized concepts. For example, a “press to set urgency” feature may allow a user to press harder on a “send” button to send a message at a higher urgency. Haptics may be used to confirm an urgency level or that an urgency level has been set. Such a setting may cause a user-generated or user-specified alert to be played on a receiving device, the user-generated or user-specified alert communicating in such a way as to reflect the pressure used to send the message.

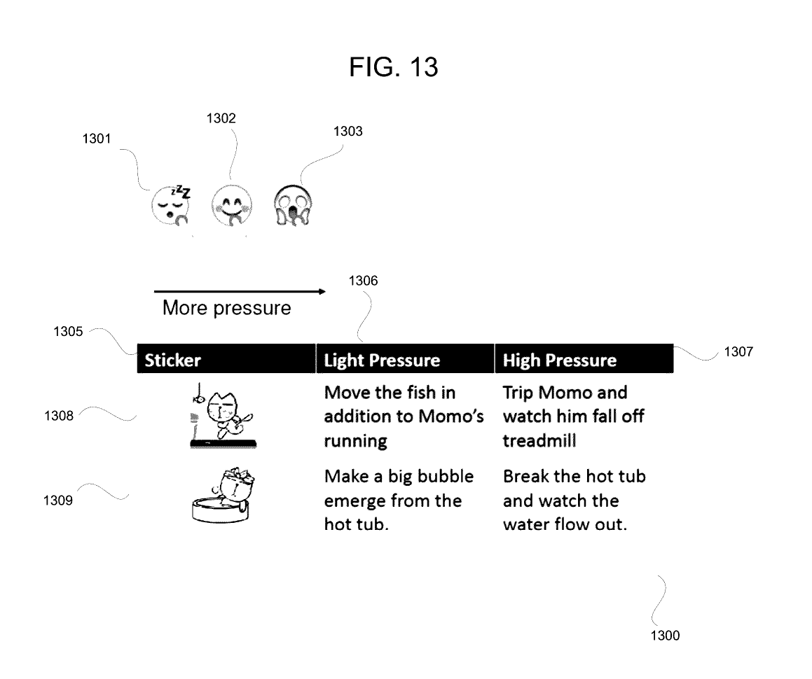

FIG. 13 illustrates another embodiment that provides for rich sticker interactions. Stickers, sometimes used in social media and texting, may involve images (including emoticons or emoji) which may be animated or changed. In an embodiment, interacting with a sticker may cause a first response 1301, applying a particular range of pressure above a first threshold may cause a second response 1302, and applying a second range of pressure above a second threshold (which may be greater than the first threshold) may cause a third and/or ultimate response 1303. Such rich sticker interactions allow for a user to interact with stickers using touch gestures and pressure gestures. A brief table 1300 illustrates rich sticker interactions and illustrates a sticker 1305, a light pressure response 1306, and a high pressure response 1307. The stickers may change in size, color, texture, haptic feedback, animation, etc., based on pressure applied when interacting with the element or sending the element. For example, first sticker 1308 may illustrate a cat on a treadmill, where a light pressure results in the cat walking towards a fish being dangled in front of the cat. Increasing pressure may cause the cat to run faster, until a high pressure is applied, resulting in the cat falling down and/or off the treadmill.

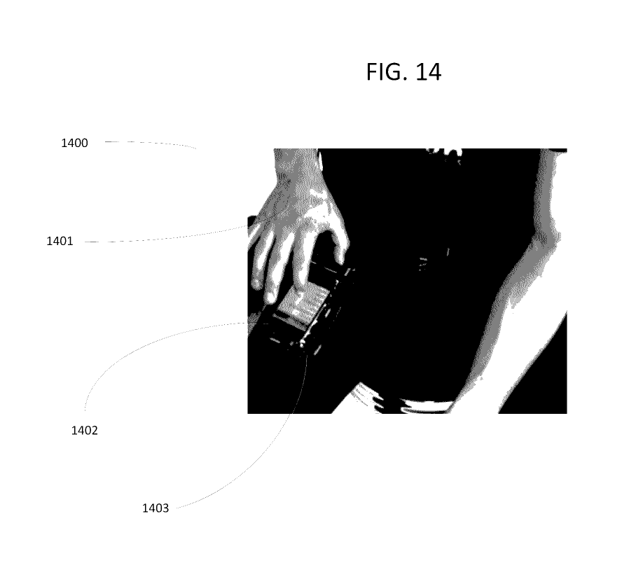

FIG. 14 illustrates another embodiment 1400, whereby a user 1401 may interact with a device 1402 via pressing to query notifications. For example, the user may press on the device while the device remains stored away, e.g., in a pocket 1403 or a bag, to feel a haptic response indicating a number, urgency, or type of notification. Pressure may be applied to a housing or a display screen. Haptic responses may be designed to convey a meaning. Beneficially, such an embodiment enables a user to conserve battery by preventing a need to turn on a screen to check notifications. In other words, the user may interact with the device without being required to look at the device.

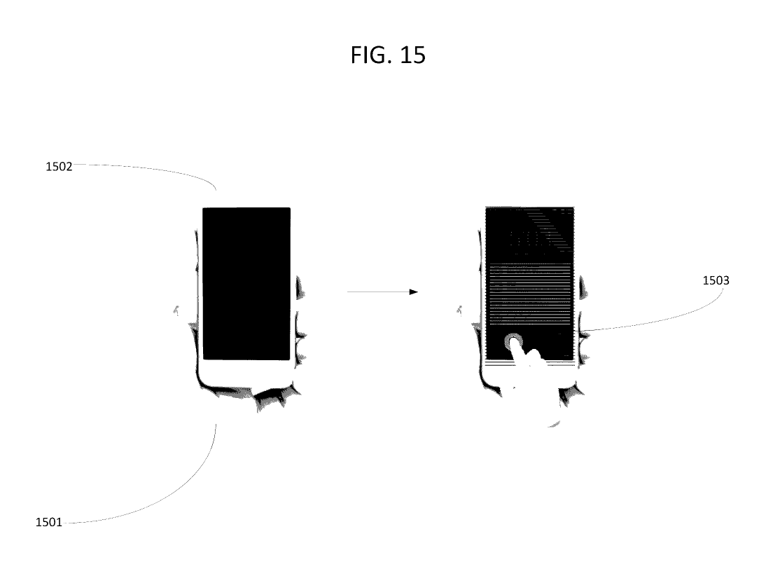

As illustrated in FIG. 15, in an embodiment, a user 1501 may use pressure to trigger a temporary screen activation on a device 1502. For example, user 1501 may apply pressure 1503 when battery power is low to show, e.g., a home screen or pending notifications. The screen may be activated using pressure for a predetermined time or as long as pressure 1503 is applied or maintained. Such enablement may lead to reduced battery consumption due to less time having the screen activated and drawing power. Additionally, such an embodiment as illustrated in FIG. 15 allows for varying or different levels of pressure to elicit additional responses from the device. For example, playful interactions including gestures and thresholds of pressure (a quantity of force or a duration of constant pressure) may lead to the device showing more notifications or providing more information to the user without fully turning on.

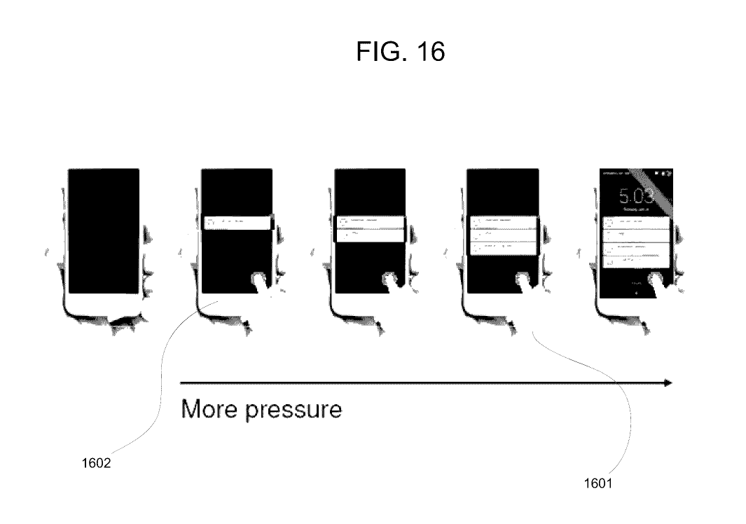

FIG. 16 illustrates an embodiment whereby more pressure being applied by user 1601 to device 1602 may result in additional notifications being displayed. The display may be accompanied by haptic responses corresponding to the number of notifications being displayed. The use of pressure applied to the screen can affect the response of the device without requiring the device to fully power up or draw a normal/regular amount of electricity.

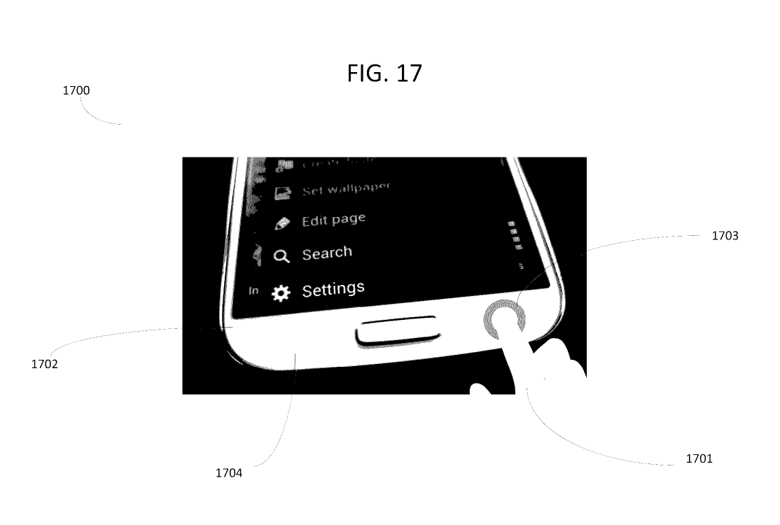

FIG. 17 illustrates an embodiment 1700, whereby a device 1702 may provide pressure-activated softkeys 1704. Softkeys, such as those provided with an Android device, are provided for interaction without having traditional buttons which require being depressed to activate. In other words, softkeys are not actually movable keys like those on a traditional keyboard or game device controller. Rather than be activated by simple touch, however, embodiment 1700 may provide softkeys which are activated by pressure 1703 instead of touch. By requiring pressure instead of simple touch, the user may reduce common errors, such as accidentally tapping a back button.

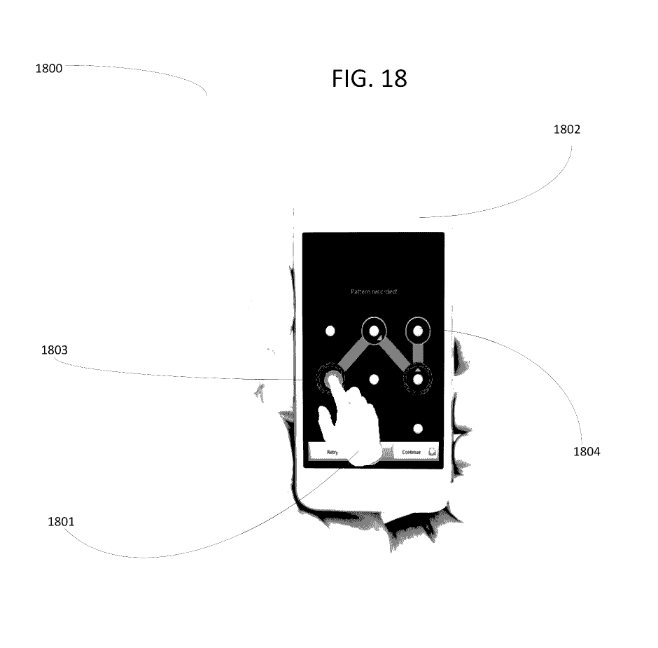

FIG. 18 illustrates another embodiment 1800, whereby pressure-based interactions may provide additional security features. In particular, pressure-based interactions may provide added unlock security. For example, a device 1802 may require a user 1801 input a pattern or specific gesture 1804 to unlock the device and allow viewing and interactions with the device and items stored and executable thereon. Such an embodiment may require applying a pressure level 1803 as part of a secure unlock sequence. Such an embodiment opens up lock screen patterns and themes, e.g., bubble wrap (which may need to be popped in a pattern).

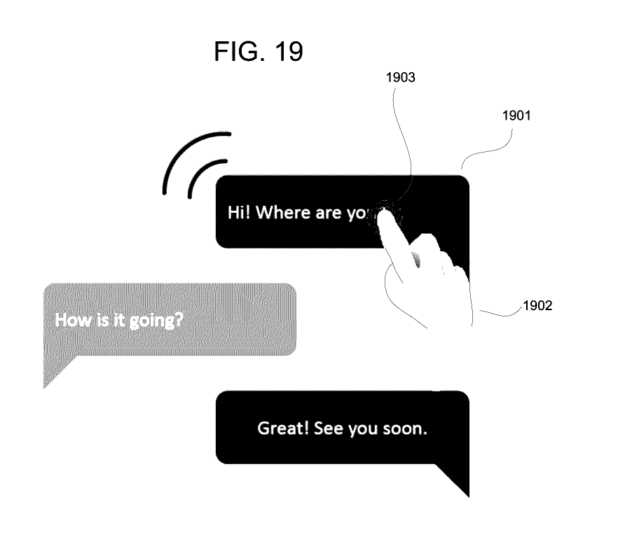

As illustrated in FIG. 19, in an ambodiment, pressure may be used to call attention to a shared visual element, such as an important text message. For example, a previously sent text message 1901 that may have been overlooked by the receiver may be activated to cause a response on the recipient's device upon the application of pressure 1903 by sender 1902 on the message on the sender's device. As such, this embodiment uses haptics and animation to call attention to previously sent messages or visuals to another person.

Additionally, in an embodiment, pressure profiles may be used for security. For example, use of consistency in pressure applied may be used as an additional layer of security. As such, a specific pressure profile may serve as a way of unlocking a device or of accessing a particular program or feature, such as use of a stored credit card.

In an embodiment, pressure may be used as triggers in lieu of “long press” triggers which may be available in some devices. Rather than needing to make contact and maintain contact with a device for a given amount of time, a user may instead provide a predetermined amount of pressure, e.g., in the form of force applied to the device. The use of pressure may reduce the time spent long-pressing and may reduce errors associated with long-press gestures.

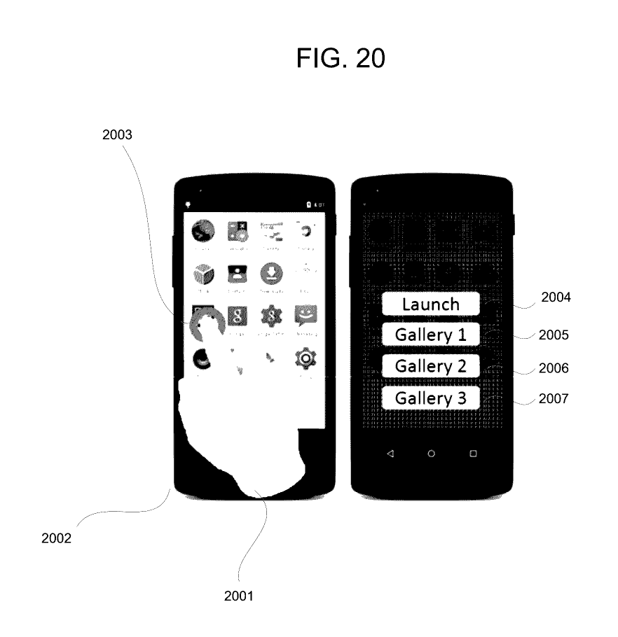

As illustrated in FIG. 20, in an embodiment, pressure may be used to provide direct to task launch in applications. A user 2001 of a device 2002 may use pressure to jump directly to application specific areas. For example, the user may open a contacts list from a phone application using a pressure press. As another example, the user may open a “gallery” application to a specific album from among a plurality of available albums based on the amount of pressure 2003 applied. In other words, a tap or minimal pressure may result in a launch 2004 of the application while increased pressure may result in launching the application to display a specific album from among galleries 1-3 (2005, 2006, 2007). The user may rely on a gesture and/or a pressure used while interacting with the device to directly access particular functions of particular applications. The device may provide haptic effects during the direct to task launch to communicate to the user the functionality that is being selected using the particular pressure and/or gesture.

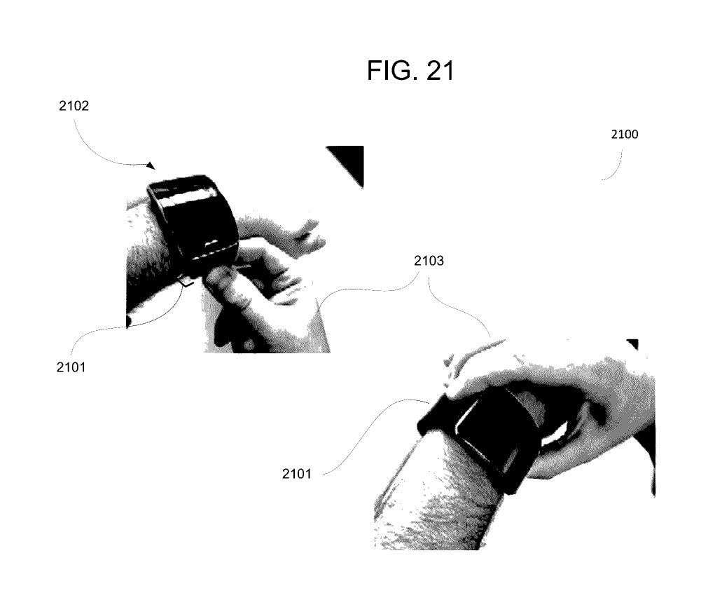

As illustrated in FIG. 21, in an embodiment 2100, pressure-sensitive regions 2101 on a wearable device 2102, e.g., a strap or case, may provide haptic feedback originating from either the strap/case or the device. By increasing the size of the pressure-sensitive region of the device, user interaction design possibilities increase. The pressure-sensitive region of the device, which may be wearable (including holdable) devices, are able to deform or otherwise provide haptic feedback to the user which may communicate alerts or other information. In other words, a user 2103 may apply pressure to a strap or case in addition or instead of an electric device to convey pressure input in an application as well as to receive haptic feedback.

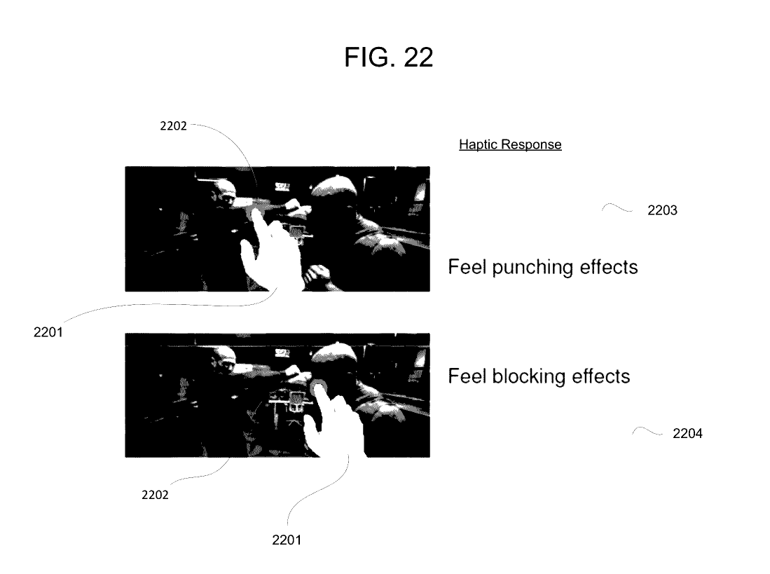

As illustrated in FIG. 22, in an embodiment, regional haptics may be generated for games and video. For example, a user 2201 of a device playing a game or a video may apply pressure 2202 to portions of a screen of the device displaying the game or video to feel what's happening at that point of contact/pressure 2202. For example, during a fight scene between two characters, the user may apply pressure to the display at a location where a punch is being thrown by a first character to feel a punching effect as a haptic response 2203 and the user may apply pressure to the display at a location where a block is raised by the second character to feel blocking effects as a haptic response 2204.

In an embodiment, a user may utilize pressure gestures applied to a device or a display screen to control functionality of feedback, e.g., haptic effects. In the embodiment, the user is required to push on the screen with a pressure to mute haptics or to allow haptic activation based on pressure.

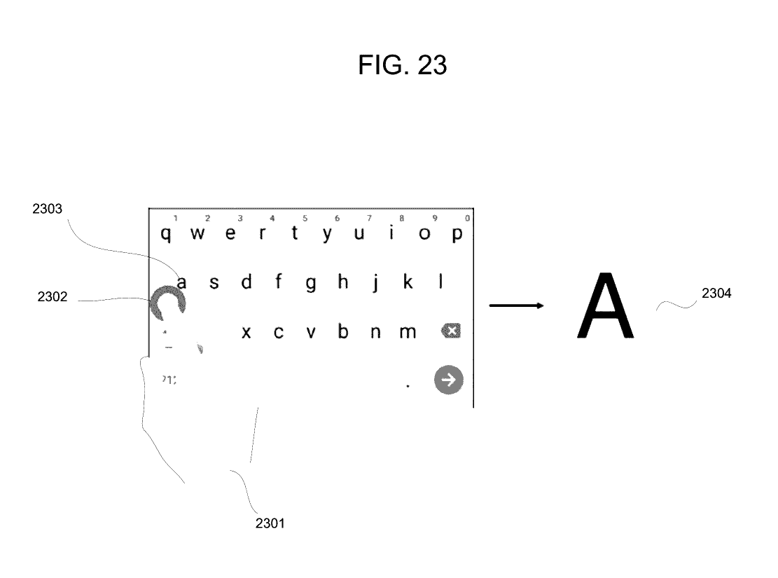

As illustrated in FIG. 23, in an embodiment, a user 2301 may apply pressure 2302 to a device for alternate key functionality. For example, the user may utilize pressure and/or a gesture to access a capital letter, caps lock, word delete, or diacritic, etc. In FIG. 23, pressing the letter “a” at 2303 with adequate pressure results in selection of a capital “A” at 2304.

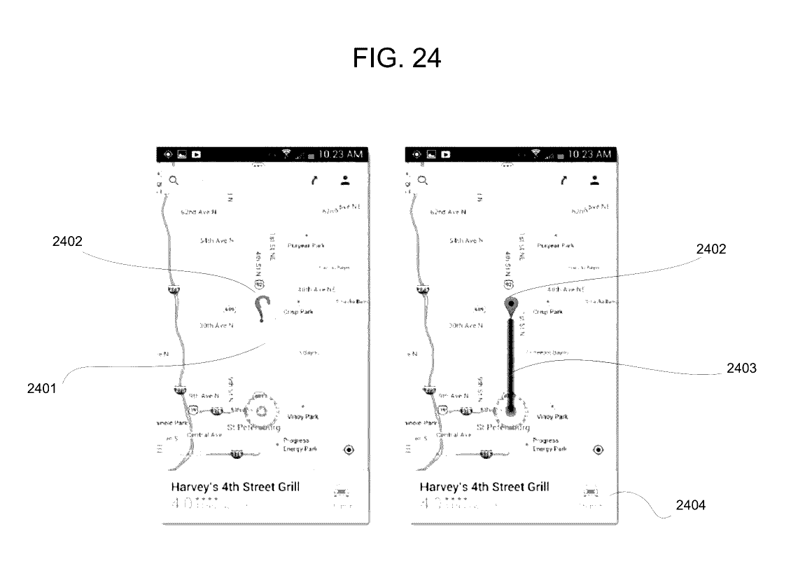

As illustrated in FIG. 24, in an embodiment, a user 2401 may apply pressure touch to quickly access turn-by-turn directions. For example, the user may apply an amount of pressure or a gesture combined with pressure to activate turn-by-turn directions. Activation of the turn-by-turn directions may be due to selecting a particular location on a map using pressure at the particular location 2402 on a device. The path to be traveled 2403 may be displayed. The amount of pressure of the combination of pressure and gesture may be used to select a method or mode of transportation 2404, e.g., walking, biking, car, transit, and taxi. Haptic effects may be provided based on the pressure and/or gesture applied to communicate the selection to the user.

In an embodiment, a user may utilize the application of pressure to allow for scrubbing forward and backward in a timeline context. Fast forwarding and rewinding rates or ending locations may be dependent on an amount of pressure applied. Rates and ending locations may also be dependent on where, i.e., a specific location, the pressure is applied. Haptic effects may be utilized to communicate the scrubbing, rates of scrubbing, and selections.

In an embodiment, a user may utilize a pressure gesture to make an electronic payment. The pressure input value required, which is closely related to the physical effort the user must make to perform the gesture, can change based on the amount to be paid. For example, paying a small sum of money could require a pressure gesture with a low amount of required pressure. Paying a large sum of money could require a high amount of pressure. In this way, the magnitude of the expenditure is represented as muscular effort, tying the sensation and effort of performing a gesture with a monetary amount, enabling a more cohesive and well-designed experience. Requiring high effort to pay a large sum of money may disincentivize spending large amounts of money, which users may desire in order to positively influence their spending habits. Additionally, requiring a high pressure value to pay large sums of money can prevent accidental payments of large amounts of money. For example, if a user wants to pay her friend $50, but accidentally inputs an extra 0 so that the system is configured to transfer $500, the amount of effort required to complete the transaction will be higher than the user expects, enabling her to notice the error before the transaction takes place.

In an embodiment, pressure may be used to provide a simulation of game physics. For example, particular locations at which pressure is applied may be used to simulate physics in games. Such a feature would be useful in air hockey, pinball, rolling ball divots, etc. In an air hockey game, touching the virtual paddle and applying pressure to it when the virtual puck collides with the virtual paddle can influence the physics model such that the virtual puck bounces off of the virtual paddle with higher force than would be the case if a high pressure input value were not sensed. Applying pressure to a location during a game may result in a device providing haptic feedback at the location related to game activities or physics.

In an embodiment, pressure may be used to simulate an activation point of a mechanical button. Physical buttons require pushing down, often against a spring, dome, or tab resisting the pushing force. Physical buttons also have tactile qualities defined by their surfaces and edges. Using the application of pressure on a display surface, a user may receive haptic feedback to simulate the edges and mechanical action of a physical button as pressure is applied. As the user applies pressure, a device provides haptic effects that simulate the tactile properties a physical button. As the user applies pressure while dragging across the display surface, haptic effects may be provided to communicate edges and/or slight lateral movements of simulated buttons, similar to how a real button might feel if a finger were to be dragged across the button.

Similarly, an embodiment may provide for utilizing pressure application as a replacement for a physical button. Buttons such as a mute switch, volume adjustment, power, home, etc., include physical switches which may be replaced with pressure sensitive regions with haptic feedback. The embodiment improves reliability of devices by reducing a number of physical parts. The embodiment enhances an industrial design with new possibilities and design freedoms. The embodiment may also enhance battery life by making it harder to accidentally turn on a display screen by pressing the physical button.

In an embodiment, pressure input may be used to enable interactions for a touchscreen that have been associated with “hover” gestures in desktop and laptop computer UIs. The use of pressure applied to a display of a device enables more pervasive access to contextual menus and data. Maintaining a particular level of pressure may be used to access a particular function instead of, e.g., a long-press functionality. The pressure application may be met with a haptic response configured to communicate to a user the amount of pressure being applied and/or the type of interaction the pressure-hover is eliciting from the device. The pressure-hover allows the user to feel an animation, for example, as a pop-up may appear and, in the case of a link or video, begins playing. Similarly, hover-pressure may be used to access and display metadata and in-line help. Unique haptic effects may be generated that match popover animations to confirm hover interactions.

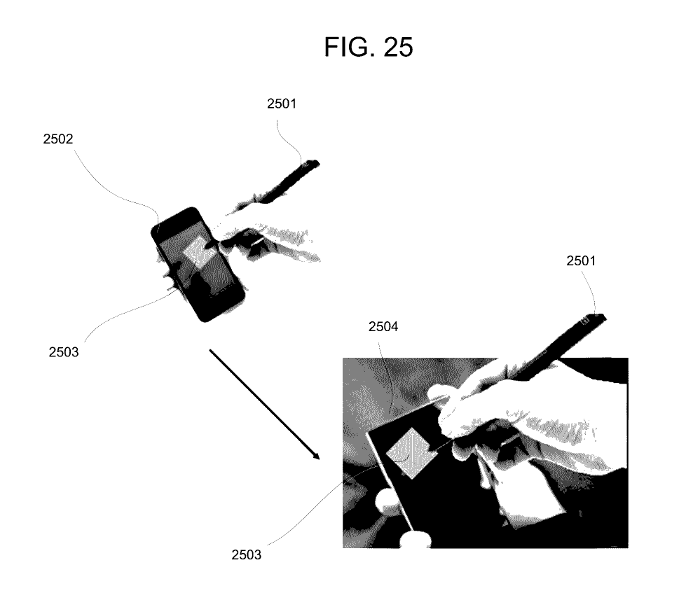

As illustrated in FIG. 25, in an embodiment, a stylus 2501 may be used with a device 2502 to grasp and move an object 2503. The stylus 2501 may be used to apply pressure to the device 2502 and objects may be then moved to a new location on the screen on which they are displayed or to another device 2504 altogether. Haptic effects may be generated by the device or the stylus to communicate the successful application of pressure, the grasping of objects, and/or the movement of the object 2503.

In an embodiment, pressure application to a device may be utilized to provide more accurate move reminders. For example, by sensing ambient pressure, a device is more accurately able to determine whether a user of the device is sitting/sedentary or active. Haptic reminders may be utilized in conjunction with the pressure sensing to indicate to the user times to get up and move after sitting for long periods of time.

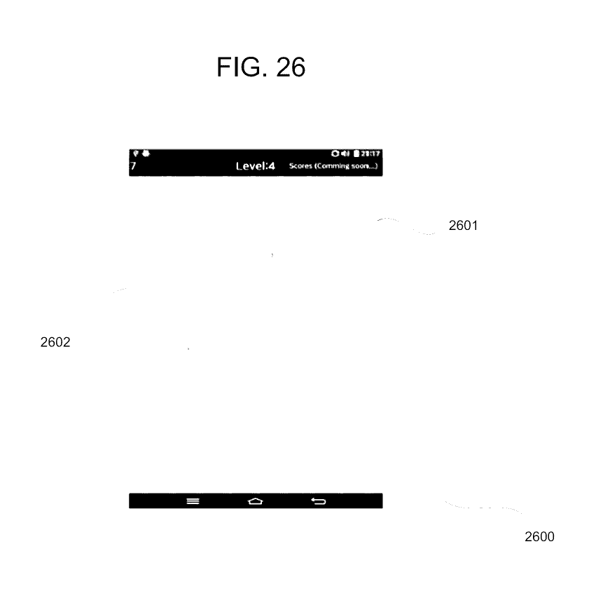

As illustrated in FIG. 26, in an embodiment, a device 2600 may create a simulated bubble wrap or the like. The device may utilize a display screen to display bubble wrap. A user may apply pressure to the displayed bubble wrap to feel the shape of the bubble wrap based on haptic effects generated in response to the applied pressure in particular locations coinciding with displayed bubbles of the bubble wrap. For example, application of light pressure would result in a first effect simulating a feeling of pressing against a bubble 2601, e.g., of air, without popping the simulated bubble. Application of increasing amounts of pressure may result in changing haptic effects being generated in response to simulate pushing harder into a bubble, and ultimately resulting in a haptic effect simulating popping a bubble 2602 upon the application of a large enough quantity of pressure on the display screen at the location of a particular bubble being simulated onscreen. Such a simulated bubble wrap may be used as a new type of a lock screen, requiring a user to apply pressure to pop particular bubbles, or particular bubbles in a particular order. Haptic effects may also be provided to communicate the successful popping of bubbles as well as a successful order if desired.

In an embodiment, pressure-based interactions with a device may be used to accomplish rich etching. Using a finger, stylus, or other peripheral, a user of a device may be able to draw or paint on the device using applied pressure. For example, brush width may be controlled by an amount of pressure applied. In the alternative, pressure may be used to cause erasing. Pressure levels may also control the type of drawing, i.e., using a pen, a brush, a spray, etc. Haptic effects may be provided to signify to the user which level of pressure is being applied and/or which effect is being utilized based on the pressure applied.

In an embodiment, a user may apply pressure to a housing of a device to modify device settings. For example, a user may grip the device using a strength setting which may signify turning the device on or off, powering up a display screen, altering volume or playback features etc. Haptic effects may be generated to communicate the force with which the device and its housing are being held, squeezed, or compressed. As such, a strength setting may be modified by application of the user grip. The grip may be characterized along sides of the housing, top and bottom, front and back, or a combination thereof.

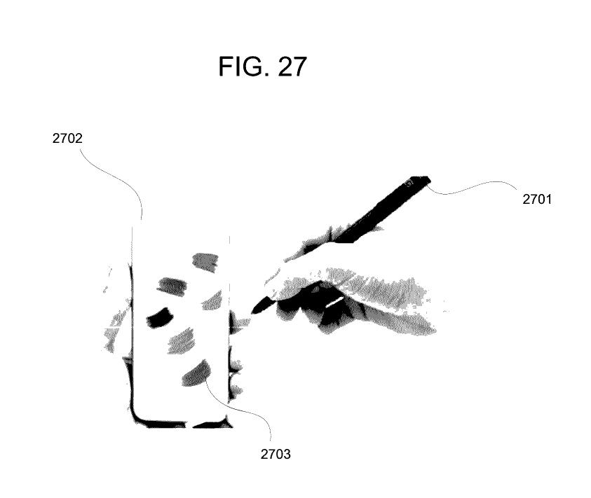

As illustrated in FIG. 27, in an embodiment, pressure may be applied to a stylus 2701 or other peripheral to change functionality of the peripheral as it interacts with a device 2702. For example, a stylus may normally be used to write on a display screen of a device as if a pen were being used. Squeezing the stylus, e.g., between the fingers, may alter the functionality such that the stylus then functions as an airbrush as illustrated at 2703. Haptic effects may be generated in the device or the peripheral to communicate the functionality of the peripheral based on pressure gesture input. In other words, haptic effects may be generated based on the pressure being applied to the peripheral. With the change in functionality, the peripheral may also interact with the device from a different distance. For example, a “pen” stylus must physically come into contact with the display screen, while an airbrush may interact with the display screen from a small distance, like a real airbrush would do, such effects, based on proximity, being able to enhance realism of the interaction.

In an embodiment, fiddle factors based on pressure thresholds and haptics may be utilized when a device is not in use.

In an embodiment, pressure application may be used to trigger a factory reset of a device. Haptic feedback is provided to a user of the device signifying the amount of pressure being applied until a threshold is crossed, which would be set to require high effort, and the device resets to factory settings.

In an embodiment, a peripheral device such as a stylus may provide haptic feedback designed to simulate the feel of wet ink being applied to paper or another surface during an interaction between the peripheral and the device. The haptic feedback can be based on the pressure applied by the peripheral when the peripheral comes into contact with the device, likely on a display screen, like an ink pen being pressed against a piece of paper or parchment.

In an embodiment, haptics and visuals respond to pressure when writing, e.g., Asian, characters. As such, the use of pressure provides an opportunity for themes. As part of a theme opportunity, haptic effects provide realistic pen input feelings to a user pressing using a finger or a peripheral. Realistic pen input may include haptic and visual responses to the user during pressure application which provides a more realistic, more pleasurable writing experience.

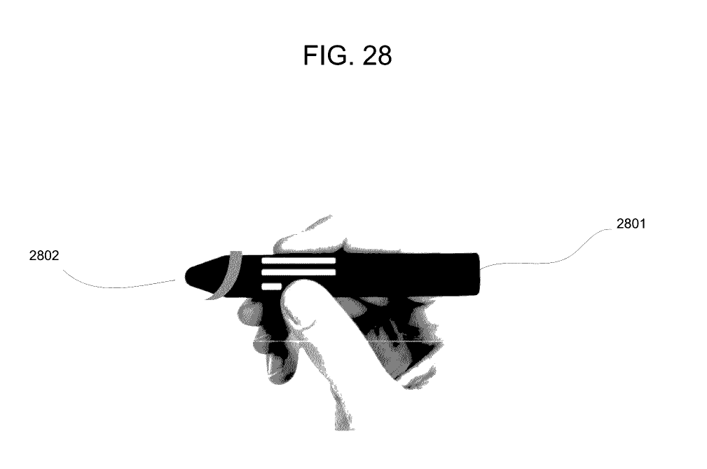

As illustrated in FIG. 28, in another embodiment, applying pressure via a peripheral, such as a stylus 2801, to a device allows a user to utilize a rolling gesture 2802 while applying the pressure to the device. Rolling stylus 2801 while applying pressure to the device with the stylus allows the user to experience ink realism and object orientation. In other words, as the user applies pressure to the device, the user may rotate stylus 2801 to generate additional functionality on the device, as well as additional haptic responses generated by the device and/or the stylus. The haptic responses generated may be based on the amount of pressure applied, the amount or speed of rotation of the stylus, the chosen functionality of the stylus with the device, or any combination thereof.

In another embodiment, pressure may be used to simulate playful physicality. A mental model of pressure applied to a device adds a playful physicality to usage of the device as pushing on user interface (“UI”) elements triggers animations based on simulated physics. For example, pushing on a display screen may cause an icon to shrink to simulate increasing its distance from the user.

In an embodiment, an inverted stylus may be used as an input. For example, by applying pressure to a stylus tip, the stylus tip may be used as a button. As such, a user of a device may apply pressure to the tip of a stylus to provide additional functionality. Pressure applied to the button may be used to take a “selfie” with an associated device, either near or from a distance. Pressure applied to the button may also be used in gaming, for example allowing the stylus to function as a joystick with an actionable button. Pressure applied to the stylus or the stylus tip may cause a generation of haptic effects. Pressure applied to the stylus or the stylus tip may also be combined with other sensors to create or modify functionality on the associated device and/or to generate responsive or associated haptic effects.

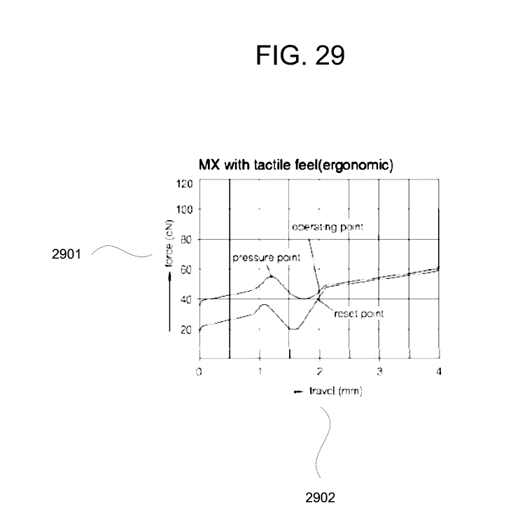

As illustrated in FIG. 29, in an embodiment, a device may produce a simulated physical keyboard. One type of physical keyboard is a mechanical keyboard, where each key comprises a mechanical switch that has certain properties. The properties of a mechanical switch can include a pressure point, an operating point, and a reset point. A simulated mechanical or physical keyboard may be a display surface of a device illustrating a keyboard, either in a standard “qwerty” configuration or a custom configuration. As a user of the device applies pressure to the display surface, haptic effects may be generated to simulate physical keys as in a physical keyboard. For example, the device may generate a force 2901, e.g., microvibrations, associated with key travel 2902, creating an illusion of key motion. As such, haptic effects may be generated to simulate moving fingers across a plurality of keys or depressing a particular key, among other effects. The particular properties of a mechanical switch such as its pressure point, operating point, and reset point can be simulated or represented with haptic feedback. Such a simulated physical keyboard may lead to performance improvements and better ergonomics.

In an embodiment, a device may utilize pressure to alter recording of video. For example, a user of a device may press to activate slow motion recording. The user may, while recording a video, apply pressure to a specific location or generally to, e.g., increase a frame rate capture. Haptic effects may be generated to signal an amount of pressure being applied, a change in functionality (i.e., change in speed or frame rate during recording), or to communicate the rate itself.

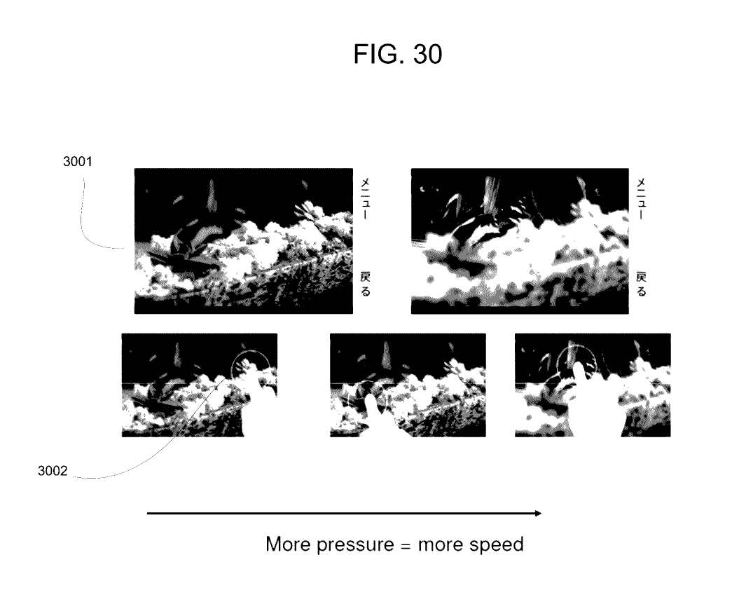

As illustrated by FIG. 30, in another embodiment, a device 3001 may be configured to sense pressure 3002 applied while in a camera mode to control a zoom rate. For example, a user may apply increasing amounts of pressure to cause the device to zoom faster. The embodiment allows the user to zoom in quickly to objects which are far away and makes the device feel like a realistic camera.

In yet another embodiment, a device may be configured to allow a user to utilize a unified focus and capture gesture while in camera mode. When using a camera or camera application, it's often necessary to tap on two different parts of the screen. One tap, on the viewfinder, focuses the lens on an object in the scene. A second tap on a shutter button captures the image. With pressure gesture sensitivity, a light touch on the viewfinder can focus the lens, and increasing pressure of that touch can capture the image. This reduces user error in tapping the wrong place, and is an easier gesture to perform. Such utility improves the usability of the camera or camera application and increases ease of use.

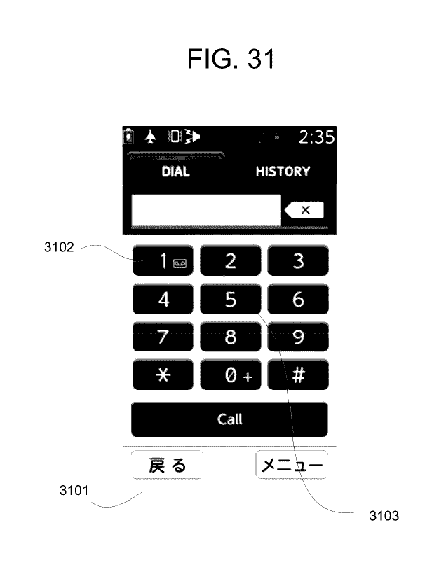

As illustrated in FIG. 31, in an embodiment, virtual buttons displayed on a device 3101 may provide keypad edge and force confirmation. As a user applies pressure to a display screen displaying at least a first virtual button 3102 (displayed as a keypad of a plurality of buttons, e.g., a phone), the device utilizes haptic effects to allow the user to feel the edges of the buttons/keys, as well as an ability to provide particular keys with specific and different haptic responses. For example, on a virtual phone pad, the number “5” may have a unique haptic response to communicate to the user a central button 3103. Haptic effects may make seeking and activating keys easier, in particular because the user does not need to lift or remove a finger from the display as an interaction occurs with multiple buttons. The combination of pressure application and haptic effects provides more realistic virtual buttons than currently available.

In an embodiment, pressure may allow a user to browse and select text displayed on a display screen of a device. The user may touch and drag to scroll through a text view. The user may press with a force to enter a selection mode. Haptic effects may be generated to confirm force gestures to the user. The combination of pressure and haptic effects serves to confirm selections, helping prevent accidental selections.

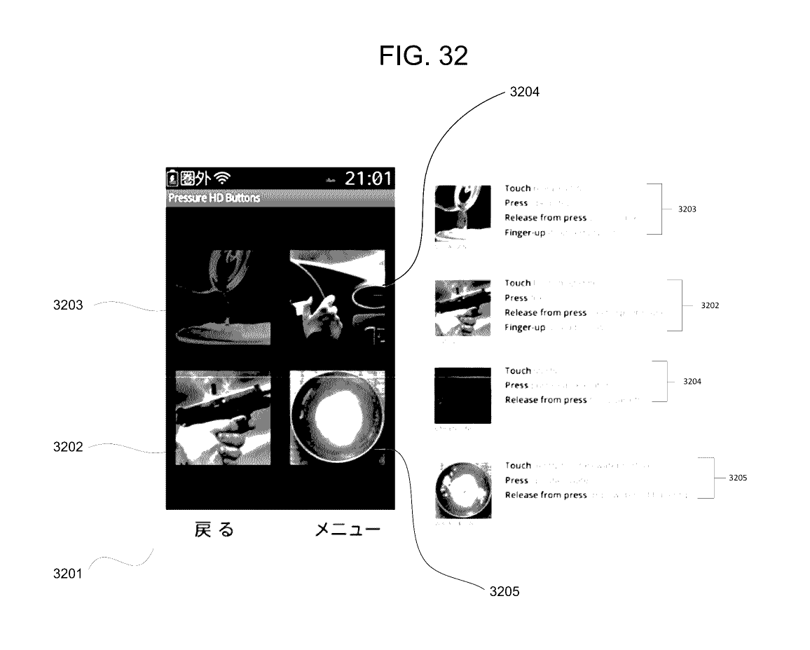

As illustrated in FIG. 32, in an embodiment, a device 3201 allows a user to apply pressure to interact with multi-stage immersive buttons. Haptic effects may be generated to signal and confirm interactions, or the haptic effects may be generated to match up with the multiple stages of each button triggered by the user. For example, the user may interact with a virtual pistol 3202, whereby an initial touch inserts a magazine, a press (force) fires the pistol, releasing from the press (decreasing pressure) racks the slide and ejects a spent round, and lifting the finger from the device (terminating the contact/touch) removes the magazine. Each of these stages can be represented with a haptic effect associated with the action of the button. Other examples of multi-stage immersion could be interactions with opening a can of soda 3203, operating a car 3204, or interaction with a bowl of water 3205. Haptics may be matched with, e.g., audio effects triggered at four different stages of a force gesture: Finger-down, force touch, release from force touch, and finger-up. Such haptic responses assist with creating convincing mental models and metaphors for UI design, rich themes, and gaming.

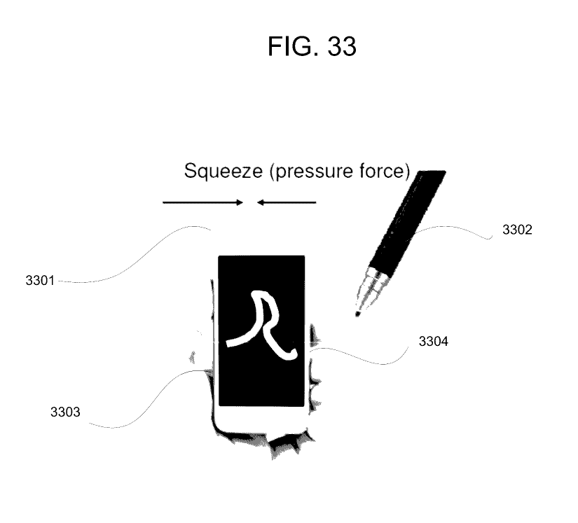

As illustrated in FIG. 33, in an embodiment, a user may apply pressure to a device 3301 to alter input from an associated stylus 3302 or other peripheral. Applying pressure to the device while using a stylus on the screen may allow the user to write across multiple virtual pages or can be used to warp a virtual page. Pressure may be applied to the device, for example, by squeezing two opposing sides 3303, 3304 of the device. Such functionality may be used in conjunction with pressure on the stylus (on a nib and/or body) or other peripheral.

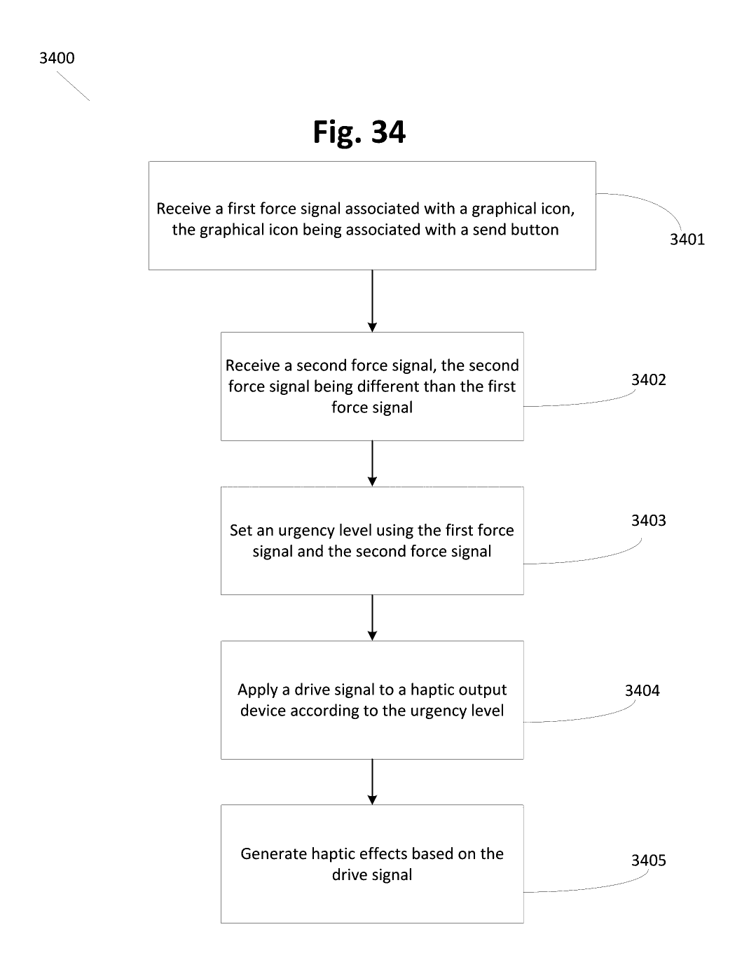

FIG. 34 provides a flowchart according to an embodiment. In the embodiment illustrated in the flowchart 3400 of FIG. 34, a device receives a first force signal associated with a graphical icon at 3401, the graphical icon representing a send button. The device then receives a second force signal which is different than the first force signal already received at 3402. The device, or a system featuring the device, sets an urgency level using the first force signal and the second force signal at 3403 and then applies a drive signal to a haptic output device according to the urgency level at 3404. Then, the device, or a system featuring the device, generates haptic effects based on the drive signal at 3405. For example, item 1901 in FIG. 19 illustrates a graphical icon that may be considered to represent a send button. Applying levels of pressure to the previously sent text message 1901 of FIG. 19 may set an urgency level which is communicated via haptic effects on a recipient's device. Additionally, a pressure may be applied to send a predetermined message, such as “Help!”, to selected or all contacts on a device.

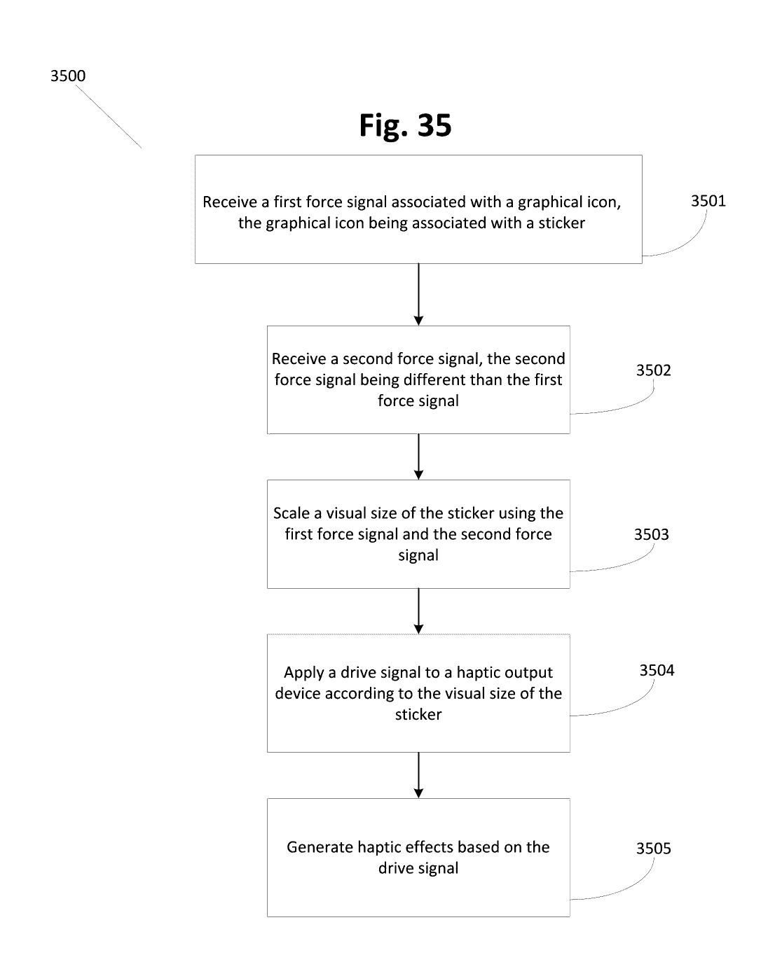

FIG. 35 provides a flowchart according to another embodiment. In the embodiment illustrated in the flowchart 3500 of FIG. 35, a device receives a first force signal associated with a graphical icon at 3501, the graphical icon representing a sticker. The device then receives a second force signal which is different than the first force signal already received at 3502. The device, or a system featuring the device, scales a visual size of the sticker using the first force signal and the second force signal at 3503 and then applies a drive signal to a haptic output device according to the visual size of the sticker at 3504. Then, the device, or a system featuring the device, generates haptic effects based on the drive signal at 3505. Stickers, like those illustrated in FIG. 13, may be scaled in size in addition to or instead of having a changing animation or image based on pressure input. Another example would be the “thumbs up” icon used in the Facebook™ application as part of its messenger service. As the user supplies multiple levels of pressure, the size of the image or thumb may be changed and a haptic effect may be generated to accompany the change in visual size.

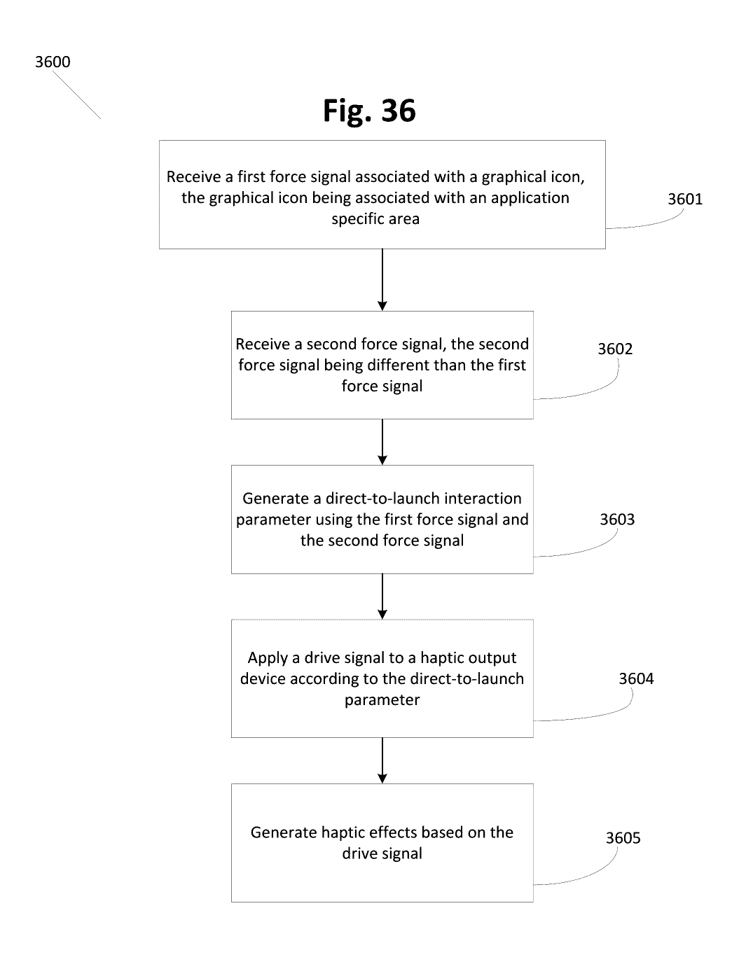

FIG. 36 provides a flowchart according to an embodiment. In the embodiment illustrated in the flowchart 3600 of FIG. 36, a device receives a first force signal associated with a graphical icon at 3601, the graphical icon representing an application specific area. The device then receives a second force signal which is different than the first force signal already received at 3602. The device, or a system featuring the device, generates a direct-to-launch interaction parameter using the first force signal and the second force signal at 3603 and then applies a drive signal to a haptic output device according to the direct-to-launch interaction parameter at 3604. Then, the device, or a system featuring the device, generates haptic effects based on the drive signal at 3605. For example, applying pressure levels to device 2002 in FIG. 20 at an application specific area (illustrated as an icon in FIG. 20), may result in the generation of a direct-to-launch parameter and accompanying haptic effect.

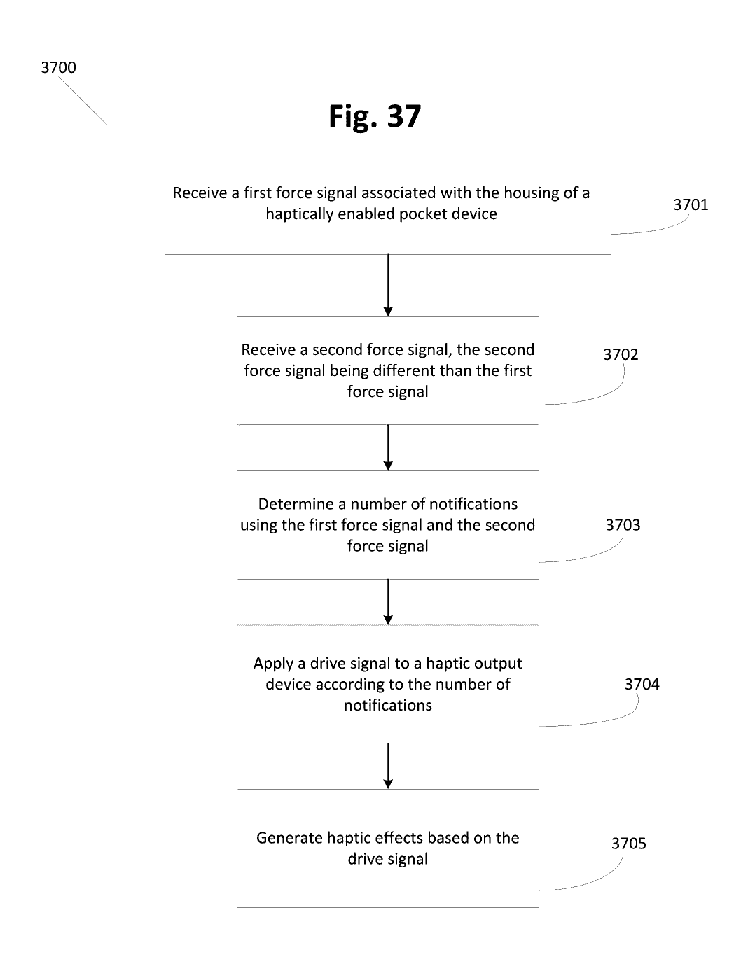

FIG. 37 provides a flowchart according to an embodiment. In the embodiment illustrated in the flowchart 3700 of FIG. 37, a device receives a first force signal associated with a housing of a haptically enabled pocket device at 3701. The device then receives a second force signal which is different than the first force signal already received at 3702. The device, or a system featuring the device, determines a number of notifications using the first force signal and the second force signal at 3703 and then applies a drive signal to a haptic output device according to the number of notifications at 3704. Then, the device, or a system featuring the device, generates haptic effects based on the drive signal at 3705. For example, applying pressure levels to device 1402 in FIG. 14 at a location on the display or to the housing itself, may result in the generation of a set of haptic effects to communicate a number of notifications awaiting the user of the device.

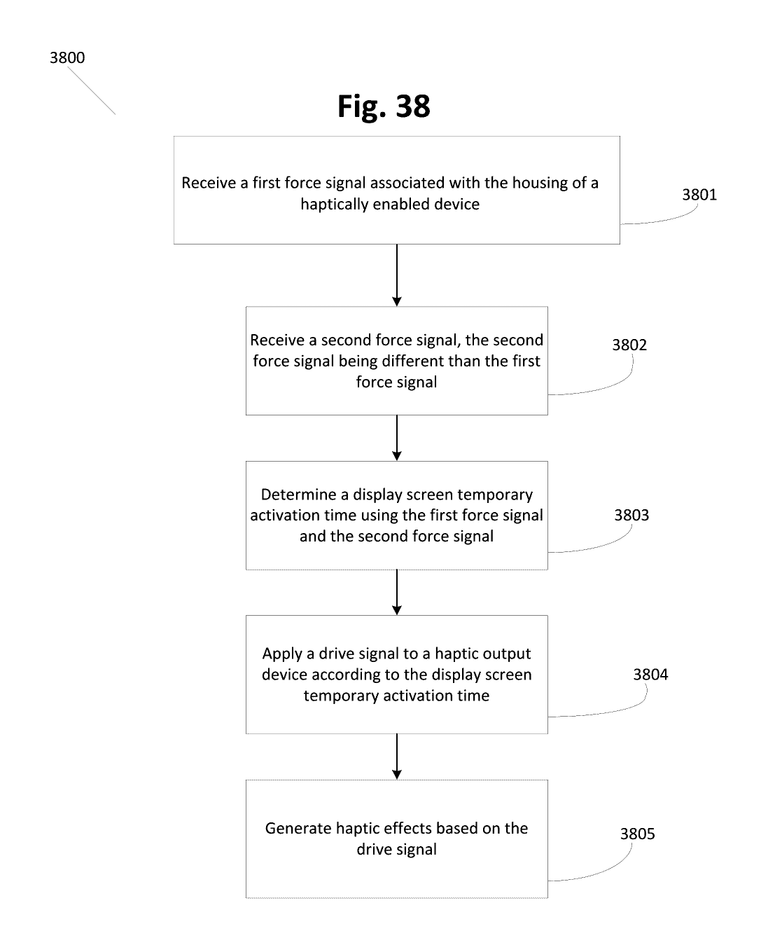

FIG. 38 provides a flowchart according to an embodiment. In the embodiment illustrated in the flowchart 3800 of FIG. 38, a device receives a first force signal associated with a housing of a haptically enabled device at 3801. The device then receives a second force signal which is different than the first force signal already received at 3802. The device, or a system featuring the device, determines a temporary screen activation time using the first force signal and the second force signal at 3803 and then applies a drive signal to a haptic output device according to the display screen temporary activation time at 3804. Then, the device, or a system featuring the device, generates haptic effects based on the drive signal at 3805. For example, applying pressure levels 1503 to device 1502 in FIG. 15 at a location on the display or to the housing itself, may result in the generation of a temporarily activated display screen and a generated haptic effect provided to the user to indicate that the screen has been activated.

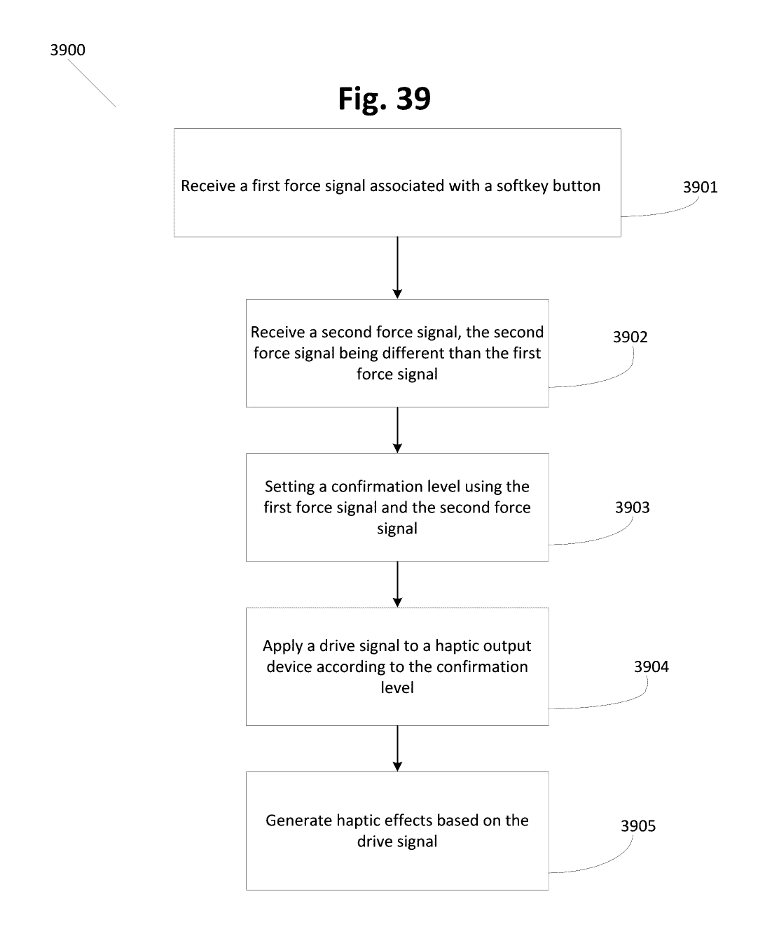

FIG. 39 provides a flowchart according to an embodiment. In the embodiment illustrated in the flowchart 3900 of FIG. 39, a device receives a first force signal associated with a softkey button at 3901. The device then receives a second force signal which is different than the first force signal already received at 3902. The device, or a system featuring the device, determines a confirmation level using the first force signal and the second force signal at 3903 and then applies a drive signal to a haptic output device according to the confirmation level at 3904. Then, the device, or a system featuring the device, generates haptic effects based on the drive signal at 3905. For example, applying pressure levels to device 1702 in FIG. 17 in the lower region of device 1702 (where the pointer ends) may include softkey buttons 1704 (as opposed to traditional rigid mechanical buttons) with which the user 1701 may interact and receive a confirmation level based haptic response based on the interaction.

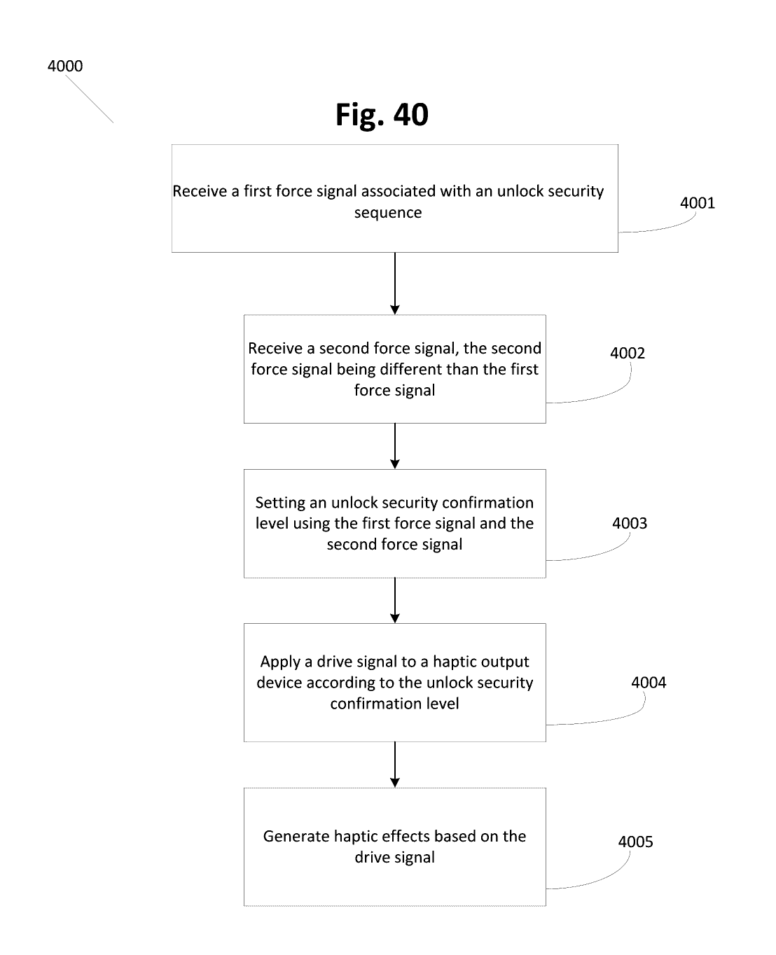

FIG. 40 provides a flowchart according to an embodiment. In the embodiment illustrated in the flowchart 4000 of FIG. 40, a device receives a first force signal associated with an unlock security sequence at 4001. The device then receives a second force signal which is different than the first force signal already received at 4002. The device, or a system featuring the device, sets an unlock security confirmation level using the first force signal and the second force signal at 4003 and then applies a drive signal to a haptic output device according to the unlock security confirmation level at 4004. Then, the device, or a system featuring the device, generates haptic effects based on the drive signal at 4005. For example, applying pressure levels 1803 to a device 1802 in FIG. 18 in a particular sequence 1804 may result in unlocking device 1802 upon setting an unlock security confirmation and the device may generate haptic effects to confirm the unlocking.

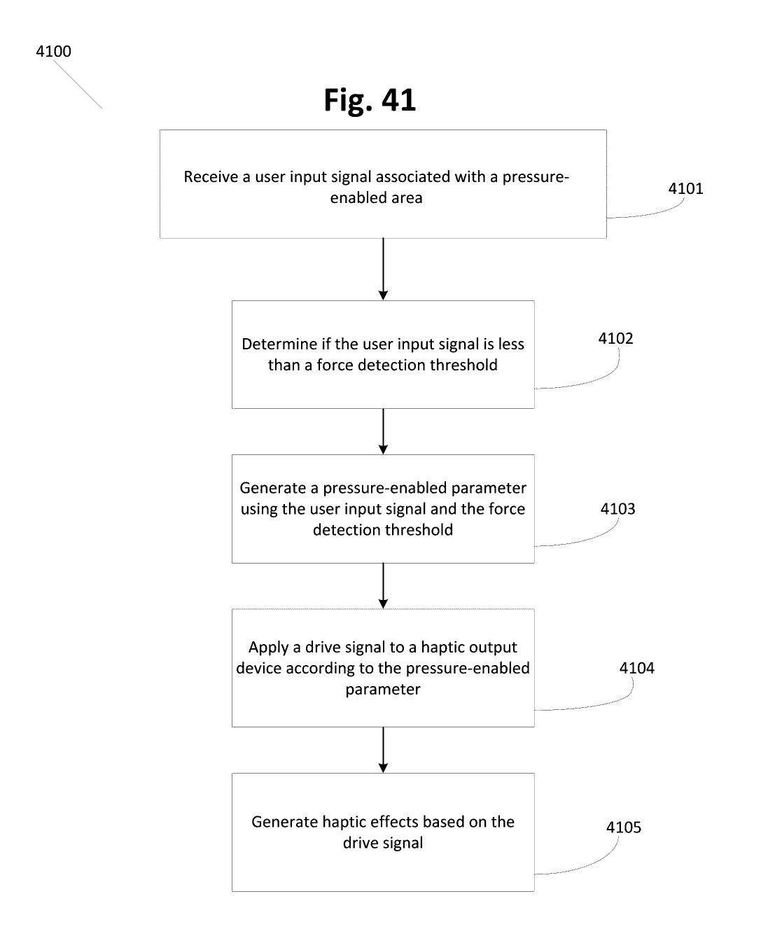

FIG. 41 provides a flowchart according to an embodiment. In the embodiment illustrated in the flowchart 4100 of FIG. 41, a device receives a user input signal associated with a pressure-enabled area at 4101, the pressure enabled area being associated with a device. The device then determines if the user input signal is less than a force detection threshold at 4102. The device, or a system featuring the device, generates a pressure-enabled parameter using the user input signal and the force detection threshold at 4103 and then applies a drive signal to a haptic output device according to the pressure-enabled parameter at 4104. Then, the device, or a system featuring the device, generates haptic effects based on the drive signal at 4105. For example, applying pressure levels to device 2502 in FIG. 25 in a pressure-enabled area (for instance at the location of object 2503) with a pressure greater than a predetermined force detection threshold, may result in haptic effects being generated to accompany the user's interaction with the device and object 2503.

Several embodiments are specifically illustrated and/or described herein. However, it will be appreciated that modifications and variations of the disclosed embodiments are covered by the above teachings and within the purview of the appended claims without departing from the spirit and intended scope of the invention.

1. A method for processing a user input on a user interface, the method comprising:
providing an affordance layer that is responsive when the user input comprises a touch or tap;
providing a first interaction layer that is responsive when the user input comprises a first pressure comprising a first threshold; and
providing a second interaction layer that is responsive when the user input comprises a second pressure comprising a second threshold.

2. The method of claim 1, wherein either the first or second threshold comprises a threshold based on one of: an amount of pressure, a duration of pressure or a frequency of pressure.

3. The method of claim 1, wherein an identity of a type of touch or tap at the affordance layer determines one of a plurality of possible functions.

4. The method of claim 1, wherein the affordance layer generates a responsive affordance layer haptic effect.

5. The method of claim 4, wherein the first interaction layer generates a responsive first interaction layer haptic effect that is different than the affordance layer haptic effect.

6. The method of claim 5, wherein the second interaction layer generates a responsive second interaction layer haptic effect that is different than the first interaction layer haptic effect.

7. The method of claim 5, wherein the first interaction layer haptic effect is temporary for a first pressure level or continuous through multiple pressure levels.

8. The method of claim 6, wherein the second interaction layer haptic effect is contextual based on a selected icon on the affordance layer.

9. A computer readable medium having instructions stored thereon that, when executed by a processor, generates responses to a user input on a user interface, the generating responses comprising:
providing an affordance layer that is responsive when the user input comprises a touch or tap;
providing a first interaction layer that is responsive when the user input comprises a first pressure comprising a first threshold; and
providing a second interaction layer that is responsive when the user input comprises a second pressure comprising a second threshold.

10. The computer readable medium of claim 9, wherein either the first or second threshold comprises a threshold based on one of: an amount of pressure, a duration of pressure or a frequency of pressure.

11. The computer readable medium of claim 9, wherein an identity of a type of touch or tap at the affordance layer determines one of a plurality of possible functions.

12. The computer readable medium of claim 9, wherein the affordance layer generates a responsive affordance layer haptic effect.

13. The computer readable medium of claim 12, wherein the first interaction layer generates a responsive first interaction layer haptic effect that is different than the affordance layer haptic effect.

14. The computer readable medium of claim 13, wherein the second interaction layer generates a responsive second interaction layer haptic effect that is different than the first interaction layer haptic effect.

15. The computer readable medium of claim 13, wherein the first interaction layer haptic effect is temporary for a first pressure level or continuous through multiple pressure levels.

16. The computer readable medium of claim 14, wherein the second interaction layer haptic effect is contextual based on a selected icon on the affordance layer.

17. A system comprising:
a user interface adapted to receiving a user input;
an affordance layer that is responsive when the user input comprises a touch or tap;
a first interaction layer that is responsive when the user input comprises a first pressure comprising a first threshold; and
a second interaction layer that is responsive when the user input comprises a second pressure comprising a second threshold.

18. The system of claim 17, wherein either the first or second threshold comprises a threshold based on one of: an amount of pressure, a duration of pressure or a frequency of pressure.

19. The system of claim 17, wherein an identity of a type of touch or tap at the affordance layer determines one of a plurality of possible functions.

20. The system of claim 17, further comprising a haptic output device, wherein the affordance layer generates a responsive affordance layer haptic effect on the haptic output device.

21. The system of claim 20, wherein the first interaction layer generates a responsive first interaction layer haptic effect on the haptic output device that is different than the affordance layer haptic effect.

22. The system of claim 21, wherein the second interaction layer generates a responsive second interaction layer haptic effect on the haptic output device that is different than the first interaction layer haptic effect.

23. The system of claim 20, wherein the first interaction layer haptic effect is temporary for a first pressure level or continuous through multiple pressure levels.

24. The system of claim 22, wherein the second interaction layer haptic effect is contextual based on a selected icon on the affordance layer.

25. (canceled)

26. (canceled)

27. (canceled)

28. (canceled)

29. The method of claim 1, further comprising:
receiving a first pressure-based input as a first user input;
applying a first drive signal to a haptic output device according to the first pressure-based input;
receiving a key frame;
receiving a second pressure-based input as a second user input different from the first pressure-based input after the key frame; and
applying an interpolated second drive signal to the haptic output device based on the difference between the first pressure-based input and the second pressure-based input to provide a transitional haptic effect.
